(19) United States
(12) Patent Application Publication
(10) Pub. No.: US 2022/0283938 A1
(43) Pub. Date: Sep. 8, 2022

(54) STORAGE SYSTEM AND STORAGE MANAGEMENT METHOD

(71) Applicant: Hitachi, Ltd., Tokyo (JP)

(72) Inventors: Hiroki FUJII, Tokyo (JP); Yoshinori OHIRA, Tokyo (JP); Takeru CHIBA, Tokyo (JP); Akira DEGUCHI, Tokyo (JP)

(73) Assignee: Hitachi, Ltd., Tokyo (JP)

(21) Appl. No.: 17/471,968

(22) Filed: Sep. 10, 2021

(30) Foreign Application Priority Data
Mar. 5, 2021 (JP) 2021-035565

(51) Int. Cl. G06F 12/06; G06F 11/10

(52) U.S. Cl. CPC G06F 12/0646; G06F 11/1004; G06F 2212/1041

(57) ABSTRACT

Element data stored in a selected virtual device is moved to another virtual device, a virtual parcel allocated to a specific physical device is allocated to a plurality of unallocated areas located in different physical devices, which are mapped to the virtual parcel in which the data is unstored by moving the element data, and all the specific physical devices are brought into an unallocated state.

### BACKGROUND OF THE INVENTION

### 1. Field of the Invention

The present invention relates to a storage system and a storage management method.

### 2. Description of the Related Art

A storage system in which a RAID (Redundant Array of Inexpensive (or Independent) Disks) group is configured by a plurality of storage devices and a logical volume created based on the RAID group is provided to an upper-level device (for example, a host computer) is known.

As a technique related to the RAID, International Publication No. 2014/115320 discloses a technique in which a stripe row including normal data and redundant data restoring the normal data are distributed and managed in a plurality of storage devices providing a storage area to a capacity pool, namely, what is called a distributed RAID system.

### SUMMARY OF THE INVENTION

Conventionally, a technique of adding a drive to a RAID group for the purpose of increasing the capacity or the like is described, but a technique of decreasing an arbitrary drive is not described.

The present invention has been made in view of the above circumstances, and an object of the present invention is to provide a storage system capable of decreasing the number of arbitrary drives in units of one drive and a storage management method.

A storage system according to one aspect of the present invention includes: a processor; and a plurality of physical devices, the processor configures a virtual chunk with k (k is an integer of at least 2) virtual parcels having element data that is user data or redundant data for repairing the user data, and stores the virtual chunk in a virtual device, and executes mapping of the virtual parcel included in an identical virtual chunk to k physical devices different from each other among N (k<N) physical devices, when M (1≤M≤N-k) physical devices are decreased from N physical devices, the processor selects M virtual devices, and moves the element data stored in the selected virtual device to another virtual device; and allocates the virtual parcel allocated to a specific physical device to a plurality of unallocated areas located in the physical devices different from each other, the plurality of unallocated area being mapped to the virtual parcel in which data is not stored by moving the element data, and brings all the specific physical devices into an unallocated state.

According to the present invention, the storage system that can be decreased in units of one drive with respect to an arbitrary drive and a storage management method can be implemented.

### BRIEF DESCRIPTION OF THE DRAWINGS

FIG. 1 is a block diagram illustrating an example of parcel mapping between a virtual storage area and a physical storage area, which are managed by a storage system according to a first embodiment;

FIG. 2 is a block diagram illustrating a hardware configuration example of a computer system to which the storage system of the first embodiment is applied;

FIG. 3 is a block diagram illustrating a configuration example of a capacity pool managed by the storage system of the first embodiment;

FIG. 4 is a block diagram illustrating an example of a data configuration of a physical device used in the storage system of the first embodiment;

FIG. 5 is a block diagram illustrating an example of page mapping of a virtual volume managed by the storage system of the first embodiment;

FIG. 6 is a block diagram illustrating an example of parcel mapping between a virtual parity group and a distributed parity group, which are managed by the storage system of the first embodiment;

FIG. 7 is a block diagram illustrating another example of parcel mapping between the virtual storage area and the physical storage area, which are managed by the storage system of the first embodiment;

FIG. 8 is a block diagram illustrating contents of a common memory managed by the storage system of the first embodiment;

FIG. 9 is a block diagram illustrating contents of a local memory of the first embodiment;

FIG. 10 is a view illustrating an example of a pool management table of the first embodiment;

FIG. 11 is a view illustrating an example of a page mapping table of the first embodiment;

FIG. 12 is a view illustrating an example of a map pointer table of the first embodiment;

FIG. 13 is a view illustrating an example of a cycle mapping table of first embodiment;

FIG. 14 is a view illustrating an example of a cycle mapping inverse transformation table of first embodiment;

FIG. 15A is a view illustrating an example of a PG mapping table of the first embodiment;

FIG. 15B is a view illustrating an example of a PG mapping inverse transformation table of the first embodiment;

FIG. 16A is a view illustrating an example of a drive mapping (V2P) table of the first embodiment;

FIG. 16B is a view illustrating an example of a drive mapping (P2V) table of the first embodiment;

FIG. 17 is a view illustrating an example of a drive # replacement management table of the first embodiment;

FIG. 18 is a block diagram illustrating an example of a parcel mapping method before the physical device used in the storage system of first embodiment is decreased;

FIG. 19 is a block diagram illustrating an example of the parcel mapping method after the physical devices used in the storage system of first embodiment is decreased;

FIG. 20 is a flowchart illustrating an example of a drive decrease processing executed in the storage system of the first embodiment;

FIG. 21 is a flowchart illustrating an example of map after decrease production processing executed in the storage system of the first embodiment;

FIG. 22 is a flowchart illustrating a single increase map producing processing executed by the storage system of the first embodiment;

FIG. 23 is a flowchart illustrating a cycle unit decrease processing executed in the storage system of the first embodiment;

FIG. 24 is a flowchart illustrating the drive # replacement processing executed by the storage system of the first embodiment;

FIG. 25 is a flowchart illustrating destage processing executed in the storage system of the first embodiment;

FIG. 26 is a flowchart illustrating VP transformation processing executed by the storage system of the first embodiment;

FIG. 27 is a flowchart illustrating PV transformation processing executed by the storage system of first embodiment;

FIG. 28 is a view illustrating a configuration of a drive enclosure of a storage system according to a second embodiment; and

FIG. 29 is a flowchart illustrating an example of drive decrease processing executed in the storage system of the second embodiment.

### DESCRIPTION OF THE PREFERRED EMBODIMENTS

A preferred embodiment of the present invention will be described with reference to the drawings. The following embodiments do not limit the invention according to the claims, and all the constituents described in the embodiments and combinations thereof are not essential for the solution to problem of the invention.

In the following description, various types of information may be described using an expression of an “aaa table”, but the various types of information may be expressed using a data structure other than the table. The “aaa table” can also be referred to as “aaa information” to indicate that the “aaa table” does not depend on the data structure.

In the following description, processing may be described with a “program” as a subject, but the subject of the processing may be a program because the program is executed by a processor (for example, a central processing unit (CPU)) to execute predetermined processing appropriately using a storage resource (for example, a memory) and/or a communication interface device (for example, a port). The processing described with the program as the subject may be processing executed by a processor or a computer (for example, a management computer, a host computer, a controller, or the like) including the processor. In addition, the controller (storage controller) may be the processor itself or may include a hardware circuit that executes a part or all the pieces of processing executed by the controller. The program may be installed in each controller from a program source. For example, the program source may be a program distribution server or a computer-readable storage medium.

In the following description, an ID is used as identification information about the element, but other types of identification information may be used instead of or in addition to the ID.

In the following description, a reference numeral or a common number in the reference numeral may be used when the same kind of elements are described without being distinguished, and the reference numeral of the element may be used, or the ID allocated to the element may be used instead of the reference numeral when the same kind of elements are described while being distinguished.

In the following description, an input/output (I/O) request is a write request or a read request, and may be referred to as an access request.

The RAID group may be referred to as a parity group (PG).

The storage system of the first embodiment has the following configuration as an example.

That is, a map production method for transforming a RAID width k into N drive spaces satisfying k≤N and a logical structure to which mapping is applied are disclosed in the storage system of the first embodiment. for the mapping production, in decreasing the drive spaces from N+1 to N, a map decreasing a moving amount of existing data is produced in order to secure a data area necessary for data redundancy, thereby decreasing the moving amount of data necessary at the time of drive decrease. In addition, an address space is defined by the drive capacity of one drive, which is an increase and decrease unit, and is provided to a user, which allows the increase and decrease by one drive. In addition, an identifier indicating a physical drive mounting position is associated with an identifier of a virtual drive, and the association is updated, thereby decreasing the moving amount of data when the drive at an arbitrary physical position is decreased.

### First Embodiment

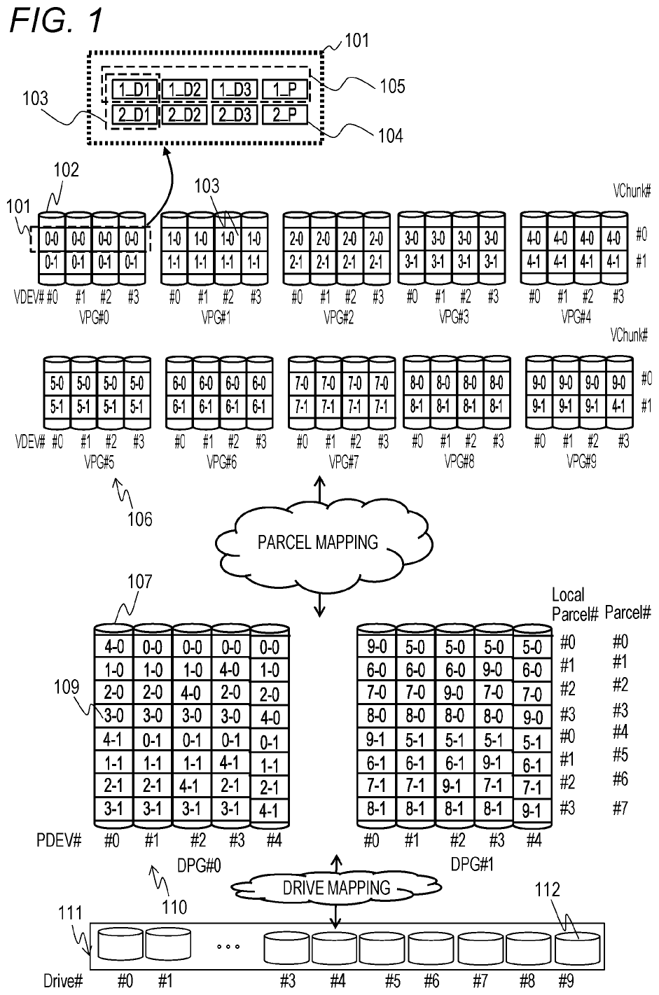

FIG. 1 illustrates an outline of mapping between a virtual storage area and a physical storage area in a computer system (storage system) of the first embodiment.

An upper part of FIG. 1 illustrates the virtual storage area, and a lower part of FIG. 1 illustrates the physical storage area.

The computer system of the first embodiment provides a virtual volume to a host, and allocates the virtual storage area provided by a virtual device (VDEV: Virtual DEVice) 102 to the virtual volume. In the example of FIG. 1, 40 virtual devices 102 are illustrated, and VDEV# (number) is given to each virtual device 102. For example, the virtual storage area is a page.

Furthermore, a virtual parity group (VPG) 106 including a plurality of virtual devices 102 is configured. In the example of FIG. 1, four virtual devices 102 configures one virtual parity group 106. In the example of FIG. 1, ten virtual parity groups 106 are illustrated, and VPG# (number) is given to each virtual parity group 106. The VDEV# indicating a position in the virtual parity group is given to the virtual device 102 belonging to each virtual parity group 106. In the example of FIG. 1, four virtual devices 102 are illustrated in each virtual parity group 106, and different VDEVs# are given to each virtual device 102.

The virtual parity group 106 is a redundant array of inexpensive disks (RAID) group, and stores a redundant data set across a plurality of virtual devices 102. The redundant data set is a data set for rebuilding data in the RAID, and includes data from the host and redundant data.

The virtual storage area is divided into virtual stripes 104 each of which has a predetermined size. The virtual stripe 104 of a specific logical address in each of the plurality of virtual devices 102 in the virtual parity group 106 configures a virtual stripe row 105. In the example of FIG. 1, four virtual stripes 104 configure one virtual stripe row 105. The virtual stripe row 105 stores the redundant data set. The redundant data set includes data D from the host and parity P based on the data D. Each virtual stripe 104 in one virtual stripe row 105 stores the data D or the parity P in the corresponding redundant data set.

The data D may be referred to as user data. The parity P may be referred to as redundant data. Data stored in each virtual stripe of the redundant data set may be referred to as element data.

In one virtual device 102, one virtual stripe 104 or a predetermined number of virtual stripes 104 having consecutive logical addresses configure one virtual parcel 103. In the example of FIG. 1, two virtual stripes 104 having consecutive logical addresses configure one virtual parcel 103.

Furthermore, a predetermined number of virtual stripe rows 105 having consecutive logical addresses configure a virtual chunk (Vchunk) 101. The virtual chunk 101 is one virtual parcel row. The virtual parcel row includes virtual parcels 103 of a specific logical address in each of the plurality of virtual devices 102 in one virtual parity group 106. In other words, one virtual chunk 101 includes at least one virtual stripe row 105 having the consecutive logical addresses. In the example of FIG. 1, one virtual chunk 101 includes two virtual stripe rows 105 having the consecutive logical addresses. In the example of FIG. 1, 20 virtual chunks 101 are illustrated, and each given a Vchunk# in the VPG 106 is given to each virtual chunk 101. When the virtual parcel 103 includes one virtual stripe 104, the virtual chunk 101 includes one virtual stripe row 105.

In the example of FIG. 1, a pair of numbers written in each virtual parcel 103 is a Vchunk identifier represented by the VPG# and the Vchunk#. For example, the virtual parcel 103 in which the Vchunk identifier is “0-1” indicates that the virtual parcel 103 belongs to VPG#=0, Vchunk#=1.

The virtual storage area is mapped on a physical storage area provided by a physical device (PDEV: Physical DEVice) 107. In the example of FIG. 1, ten physical devices 107 are illustrated, and a PDEV# that is a virtual management number is given to each physical device 107. A distributed parity group (DPG) 110 including a plurality of physical devices 107 is configured. In the example of FIG. 1, five physical devices 107 configure one distributed parity group 110. In the example of FIG. 1, two distributed parity groups 110 are illustrated, and a DPG# is given to each distributed parity group 110. The mapping between the virtual storage area and the physical storage area may be referred to as parcel mapping. In addition, a physical device (PDEV) # indicating a position in the distributed parity group is given to each drive belonging to each distributed parity group 110. In the example of FIG. 1, five physical devices 107 are illustrated in each distributed parity group 110, and different PDEVs# are given to each physical device 107.

The PDEV# corresponds to a drive#, which is an identifier indicating a physical mounting position of a physical device 112 in a drive enclosure 111, on a one-to-one basis. In the example of FIG. 1, ten physical devices 112 and ten mounting positions #0 to #9 are illustrated, and mapping indicating correspondence between the two is referred to as drive mapping.

Each virtual parcel 103 in the virtual chunk 101 is mapped to a physical parcel 109 in the physical storage area. A number in each physical parcel 109 indicates the Vchunk identifier (VPG# and Vchunk#) to which the corresponding virtual parcel 103 belongs. In the example of FIG. 1, five physical parcels 109 are illustrated for each PDEV, a parcel# is given to each physical parcel 109. Each physical parcel 109 is identified by the parcel#, the PDEV#, and the DPG#. The mounting position of the physical drive is further identified by transforming the PDEV# and the drive# using the drive mapping table.

In the example of FIG. 1, the plurality of virtual parcels 103 in the virtual chunk 101 are mapped to the plurality of different physical devices 107 for the purpose of fault recovery. In other words, the plurality of virtual stripes 104 in the virtual stripe row 105 is also mapped to the plurality of different physical devices 107. Thus, the redundant data set includes the element data (the data D or the parity P) of the number of physical devices in the distributed parity group, and are written in the physical devices 107 of the number of physical devices in the distributed parity group.

The parcel mapping satisfies a mapping condition. The mapping condition is that each virtual chunk 101 is mapped to the plurality of physical devices 107. In other words, the mapping condition is that a plurality of physical parcels 109 in one physical device 107 are not mapped to the same virtual chunk 101.

A computer system of the first embodiment will be described below.

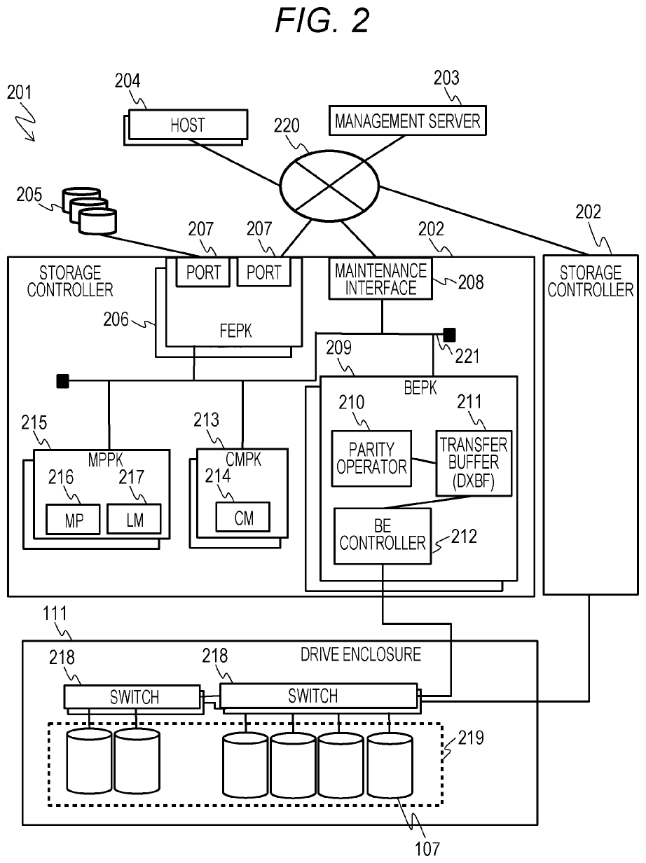

FIG. 2 illustrates a hardware configuration of the computer system of the first embodiment.

A computer system 201 includes at least one host computer (hereinafter, referred to as a host) 204, a management server 203, a storage controller 202, and a drive enclosure 111. The host 204, the management server 203, and the storage controller 202 are connected to each other through a network 220. The drive enclosure 111 is connected to the storage controller 202. The network 220 may be a local area network (LAN) or a wide area network (WAN). The host 204 and the storage controller 202 may be one computer. In addition, each of the host 204 and the storage controller 202 may be a virtual machine.

For example, the host 204 is a computer that executes an application, reads data used by the application from the storage controller 202, and writes data produced by the application in the storage controller 202.

The management server 203 is a computer used by an administrator. The management server 203 may include an input device that inputs information and an output device that displays information. The management server 203 accepts setting of a type of data restoration processing for restoring the data by operation of the administrator to the input device, and sets the data restoration processing accepted by the storage controller 202 to be executed.

For example, the storage system includes the storage controller 202 and the drive enclosure 111. The drive enclosure 111 includes a plurality of physical devices 107 (also simply referred to as a drive). For example, the physical device 107 is a magnetic disk, a flash memory, or other non-volatile semiconductor memories (PRAM, ReRAM, and the like). An external storage device 205 may be connected to this configuration. For example, the external storage device 205 is a storage system different from the above-described storage system, and the storage controller 202 reads and writes data from and to a physical device in the external storage device 205 through a system controller in the external storage device 205.

The storage controller 202 includes at least one frontend package (FEPK) 206, a maintenance interface (maintenance I/F) 208, at least one microprocessor package (MPPK) 215, at least one cache memory package (CMPK) 213, at least one backend package (BEPK) 209, and an internal network 221.

The FEPK 206, the maintenance I/F 208, the MPPK 215, the CMPK 213, and the BEPK 209 are connected to each other through an internal network 221. The BEPK 209 is connected to the drive enclosure 111 through a plurality of paths.

The FEPK 206 is an example of an interface with the host 204, and has at least one port 207. The port 207 connects the storage controller 202 to various devices through the network 220 or the like. The maintenance I/F 208 is an interface that connects the storage controller 202 to the management server 203.

The MPPK 215 is a controller, and includes at least one microprocessor (MP) 216 and a local memory (LM) 217. The MP 216 executes a program stored in the LM 217 to execute various processes. The MP 216 transmits various commands (for example, a READ command or a WRITE command in SCSI) to the physical device 107 in the drive enclosure 111 through the BEPK 209. The LM 217 stores various programs and various types of information.

The CMPK 213 includes at least one cache memory (CM) 214. The CM 214 temporarily stores data (write data) written from the host 204 in the physical device 107 and data (read data) read from the physical device 107.

The BEPK 209 is an example of an interface with the drive enclosure 111, and has at least one port 207. The BEPK 209 includes a parity operator 210, a transfer buffer (DXBF) 211, and a BE controller 212. During writing the data in the drive enclosure 111, data redundancy is performed using the parity operator 210, and the data is transferred to the drive enclosure 111 by the BE controller 212. When the data needs to be restored from the redundant data during reading the data from the drive enclosure 111, the data is restored using the parity operator 210. The transfer buffer (DXBF) 211 temporarily stores the data during the above data processing.

The drive enclosure 111 includes the plurality of physical devices 107. The physical device 107 includes at least one storage media. For example, the storage medium is a magnetic disk, a flash memory, or other non-volatile semiconductor memories (PRAM, ReRAM, and the like). The at least one physical device 107 is connected to the BE controller 212 through the switch 218. A group of physical devices 107 connected to the same BE controller is referred to as a path group 219.

The storage controller 202 manages a capacity pool (hereinafter, simply referred to as a pool) configured by storage areas of the plurality of physical devices 107. The storage controller 202 configures a RAID group using the storage area in the pool. That is, the storage controller 202 configures a plurality of virtual parity groups (VPG) using the plurality of physical devices 107. The VPG is a virtual RAID group.

The storage area of the VPG includes a plurality of sub-storage area rows. Each sub-storage area row includes a plurality of sub-storage areas. The plurality of sub-storage areas extend across the plurality of physical devices 107 constituting the VPG, and correspond to the plurality of physical devices 107. At this point, one sub-storage area is referred to as a “stripe”, and the sub-storage area row is referred to as a “stripe row”. The storage area of the RAID group is configured by a plurality of stripe rows.

The RAID has several levels (hereinafter, referred to as a “RAID level”). For example, in a RAID 5, the data of a writing target designated by a host computer corresponding to the RAID 5 is divided into pieces of data (hereinafter, referred to as a “data unit” for convenience) having predetermined sizes. Each data unit is divided into a plurality of data elements. The plurality of data elements are written into a plurality of stripes in the same stripe row.

In the RAID 5, when a failure occurs in the physical device 107, redundant information (hereinafter, referred to as a “redundant code”) called “parity” is generated for each data unit in order to rebuild the data element that cannot be read from the physical device 107. The redundant code is also written in a stripe in the same stripe row as the plurality of data elements.

For example, when the number of physical devices 107 constituting the RAID group is 4, three data elements constituting the data unit are written in three stripes corresponding to the three physical devices 107, and the redundant code is written in the stripe corresponding to the remaining one physical device 107. Hereinafter, when the data element and the redundant code are not distinguished from each other, each of the data element and the redundant code may be referred to as a stripe data element.

In a RAID 6, two types of redundant codes (referred to as P parity and Q parity) are generated for each data unit, and each redundant code is written in the stripe in the same stripe row. Thus, when two data elements among the plurality of data elements constituting the data unit cannot be read, these two data elements can be restored.

In addition to the above description, there is a RAID level (for example, RAIDS 1 to 4). As a data redundancy technology, there are triple mirror (triplication), triple parity technique using three parities, and the like. Also for the redundant code generation technique, there are various techniques such as a Reed-Solomon code using Galois operation and EVEN-ODD. Hereinafter, the RAID 5 or 6 will be mainly described, but the redundancy technique can be replaced with the above-described method.

When any physical device 107 among the physical devices 107 fails, the storage controller 202 restores the data element stored in the failed physical device 107.

The MP 216 in the MPPK 215 acquires the stripe data element (for example, other data elements and parity) necessary for restoring the data element stored in the failed physical device 107 from the plurality of physical devices 107 storing the data. The MP 216 stores the acquired stripe data element in the cache memory (CM) 214 through an interface device (for example, BEPK 209). Thereafter, the data element is restored based on the stripe data element of the cache memory 214, and the data element is stored in a predetermined physical device 107.

For example, with respect to the data unit of the RAID group configured by the RAID 5, the MP 216 generates the P parity by taking an exclusive OR (XOR) of the plurality of data elements constituting the data unit. With respect to the data unit of the RAID group configured by the RAID 6, the MP 216 further multiplies the plurality of data elements configuring the data unit by a predetermined coefficient and then takes the exclusive OR of each data to generate the Q parity.

Hereinafter, the operation of the MP 216 may be described as the operation of the storage controller 202.

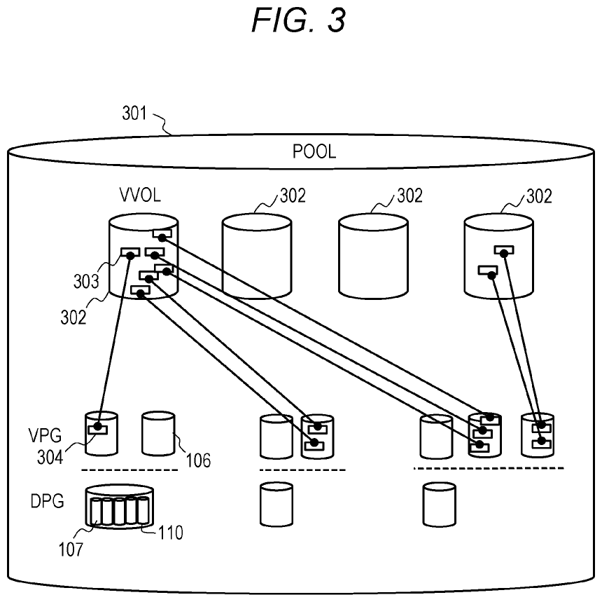

FIG. 3 illustrates a logical configuration of the computer system of the first embodiment.

The storage controller 202 bundles a plurality (for example, five) of physical devices 107 to form a distributed parity group (DPG) 110. The storage controller 202 configures at least one distributed parity group 110 and at least one virtual parity group (VPG) 106 corresponding to the distributed parity group 110. The storage controller 202 allocates a partial storage area of the DPG 110 to the VPG 106.

A plurality of virtual volumes (VVOL) 302 exists in the pool 301. The VVOL 302 is a virtual storage device, and can be referred to by the host 204. In response to an instruction from the administrator of the storage controller 202, the management server 203 causes the storage controller 202 to produce the VVOL 302 having an arbitrary size through the maintenance I/F 208. The size does not depend on the actual total capacity of the physical device 107. The storage controller 202 dynamically allocates the storage area (VPG page 304) in the VPG to the storage area (VVOL page 303) in the VVOL 302 indicated by the I/O request (host I/O) from the host 204.

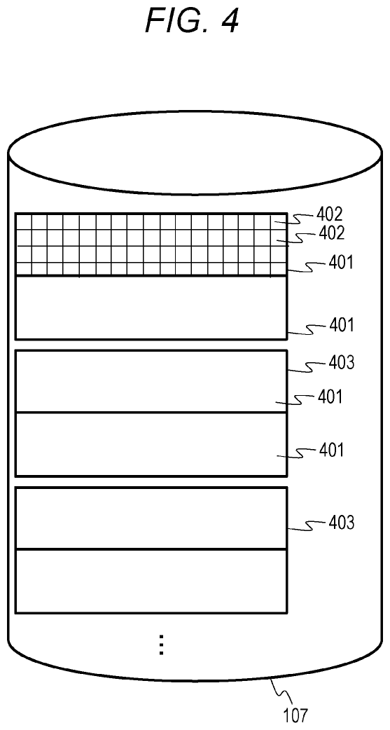

FIG. 4 illustrates a data configuration of the physical device.

The physical device 107 exchanges data with an upper-level device such as the storage controller 202 in units of a sub-block 402 that is a minimum unit (for example, 512 bytes) of SCSI command processing. The slot 401 is a management unit when the data on the cache memory 214 is cached, and is, for example, 256 KB. The slot 401 includes a set of a plurality of consecutive sub-blocks 402. The physical stripe 403 stores a plurality (for example, two) of slots 401.

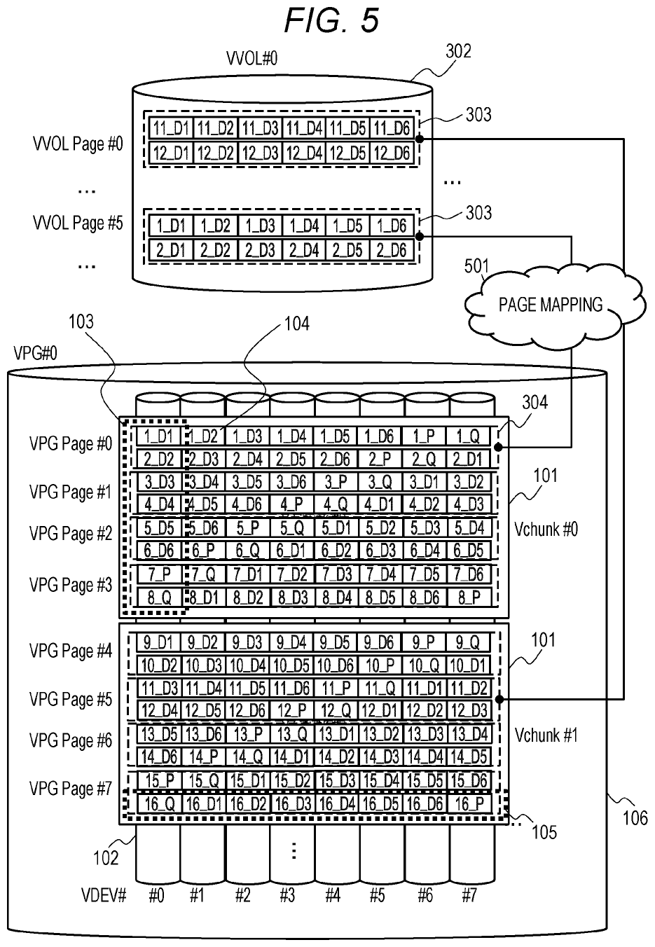

FIG. 5 illustrates page mapping of a virtual volume.

The VVOL 302 recognizable by the host 204 includes a plurality of VVOL pages 303. The VVOL 302 has a unique identifier (VVOL number). The storage controller 202 allocates a VPG page 304 in the VPG 106 to the VVOL page 303. This relationship is referred to as page mapping 501. The page mapping 501 is dynamically managed by the storage controller 202. Addresses of consecutive VVOL spaces are given to the plurality of VVOL pages having consecutive VVOL pages#.

The VPG 106 includes at least one virtual chunk (Vchunks) 101. The Vchunk 101 includes the plurality of virtual parcels 103. In the example of FIG. 5, the Vchunk 101 includes eight virtual parcels 103.

The virtual parcel 103 is configured by a continuous area in one virtual device 102. The virtual parcel 103 includes one or a plurality of virtual stripes 104. In the example of FIG. 5, the virtual parcel 103 includes eight virtual stripes 104. The number of virtual stripes 104 in the virtual parcel 103 is not particularly limited. Because the virtual parcel 103 includes the plurality of virtual stripes 104, efficiency of processing is implemented.

In the example of FIG. 5, the VPG 106 stores six data elements (D) constituting a (6D+2P) configuration of the RAID 6, namely, the data unit and two parities (P, Q) corresponding to these data elements in different physical devices 107. In this case, for example, the Vchunk 101 includes the virtual parcels 103 of eight different physical devices 107.

In other words, the Vchunk 101 is configured by a plurality of virtual stripe rows 105, and is configured by eight virtual stripe rows 105 in the example of FIG. 5. Because the Vchunk 101 includes the plurality of virtual stripe rows 105, the processing efficiency is improved. The Vchunk 101 may be configured by one virtual stripe row 105.

The Vchunk 101 includes a plurality (for example, 4) of VPG pages 304. The VPG page 304 may store stripe data elements of the plurality (for example, two) of consecutive virtual stripe rows 105. For example, by setting the plurality of data units to several MBs, sequential performance of the host I/O can be kept constant even when the physical device 107 is a magnetic disk or the like.

In FIG. 5, common numerals before “_” such as 1_D1, 1_D2, 1_D3, 1_D4, 1_D5, 1_D6, 1_P, and 1_Q indicate the stripe data elements of the same virtual stripe row 105. The size of each stripe data element is the size of the physical stripe 403.

The VPG 106 has a unique identifier (VPG number) in the upper-level storage system. A drive number (VDEV number) is given to each of K virtual devices 102 in each VPG 106. This is an identifier addressing the storage area in the VPG 106, and is an identifier representing a correspondence relationship with a drive (PDEV) in the DPG 110 (described later). Sometimes K is referred to as a VPG drive number.

Each VVOL 302 is accessed from the host 204 using the identifier representing the VVOL 302 and an LBA. As illustrated in FIG. 5, a VVOL Page# is given to the VVOL page 303 from the head of the VVOL 302. For the LBA designated by the host I/O, the VVOL Page# can be calculated by the following equation. At this point, Floor(x) is a symbol indicating a maximum integer less than or equal to x with respect to a real number x. Each of the LBA and VVOL Pagesize may be represented by a number of sub-blocks.

VVOL Page#=Floor (LBA/VVOL Pagesize)

In addition, each of the VVOL page 303 and the VPG page 304 includes a plurality of virtual stripes. However, the parity is not visible on the VVOL 302 because the host 204 is not allowed to access the parity data. For example, in the case of 6D+2P in FIG. 5, the VPG page 304 including 8×2 virtual stripes in the space of the VPG 106 appears as the VVOL page 303 including 6×2 virtual stripes in the space of the VVOL 302.

By correcting the space of the VPG 106 and the space of the VVOL 302, the storage controller 202 can calculate the VDEV# and the Vchunk# in the VPG# corresponding to the LBA on the side of the VVOL 302 and an offset address in the virtual parcel 103 together with the page mapping 501. Of course, the storage controller 202 can also calculate the VDEV# and the Vchunk# in the VPG# of the parity area corresponding to the host I/O, and the offset address in the virtual parcel 103.

FIG. 5 illustrates the case where the RAID 6 (6D+2P) is used. However, for example, a number of D such as 14D+2P may be increased, or the RAID 5 or the RAID 1 may be used. In addition, the virtual parcel of only the parity such as the RAID 4 may be produced. In the case of the normal RAID 4, there is an advantage that logical design of the upper layer can be simplified, and there is a disadvantage that the parity drive easily becomes a bottleneck because access is concentrated on the parity drive at the time of write. However, in the case of the distributed RAID configuration, because the data in the parity drive on the VPG 106 is distributed to a plurality of physical devices 107 on the DPG 110, the influence of the disadvantage can be minimized. In addition to a Galois operation, other generally known methods such as an EVEN-ODD method may be used for encoding the Q parity in the RAID 6.

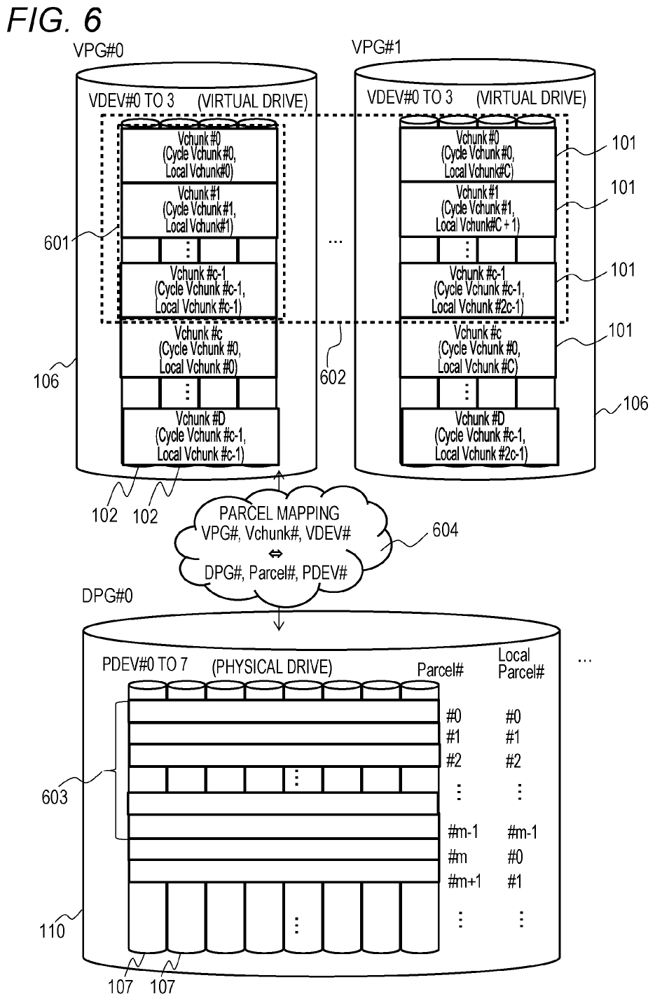

FIG. 6 illustrates the parcel mapping between the VPG and the DPG.

As described above, the Vchunk 101 is consecutive in the space of the storage area of the VPG 106. The consecutive c Vchunks 101 configure a Vchunk period 601. In the N physical devices 107 constituting the DPG 110, m consecutive Parcels 109 and a total of N×m Parcels among the physical devices 107 constitute a Parcel cycle 603. c is referred to as a number of period Vchunks. m is referred to as a number of period Parcels. For at least one VPG including the common DPG 110, a set of Vchunk periods having the common Vchunk period# is referred to as a Vchunk period group 602.

One Vchunk period group 602 corresponds to one Parcel cycle 603. In addition, parcel mapping 604 is periodic. That is, the parcel mapping 604 is common in each pair of the Vchunk period group 602 and the Parcel cycle 603. The parcel mapping 604 between the virtual storage area and the physical storage area is periodic, so that the data can be appropriately distributed to the plurality of physical storage areas, and efficient management of the parcel mapping 604 is performed. Non-periodic, namely, the parcel mapping of only one period may be adopted.

The identifier of the Vchunk 101 in each Vchunk period 601 is represented by a Cycle Vchunk# (CVC#). Consequently, the CVC# takes a value from 0 to c-1. The identifier of Parcel 108 in the Parcel cycle 603 is represented by a Local Parcel# (LPC#). The LPC# takes a value from 0 to m-1. A plurality of physical parcels 109 are allocated to data entities of a plurality of virtual parcels in one Vchunk 101.

The identifier of the Vchunk 101 in the Vchunk period group 602 is represented by a Local Vchunk# (LVC#). The LVC# is uniquely obtained from the VPG# n and the CVC#.

LVC# is obtained from n×C+CVC#.

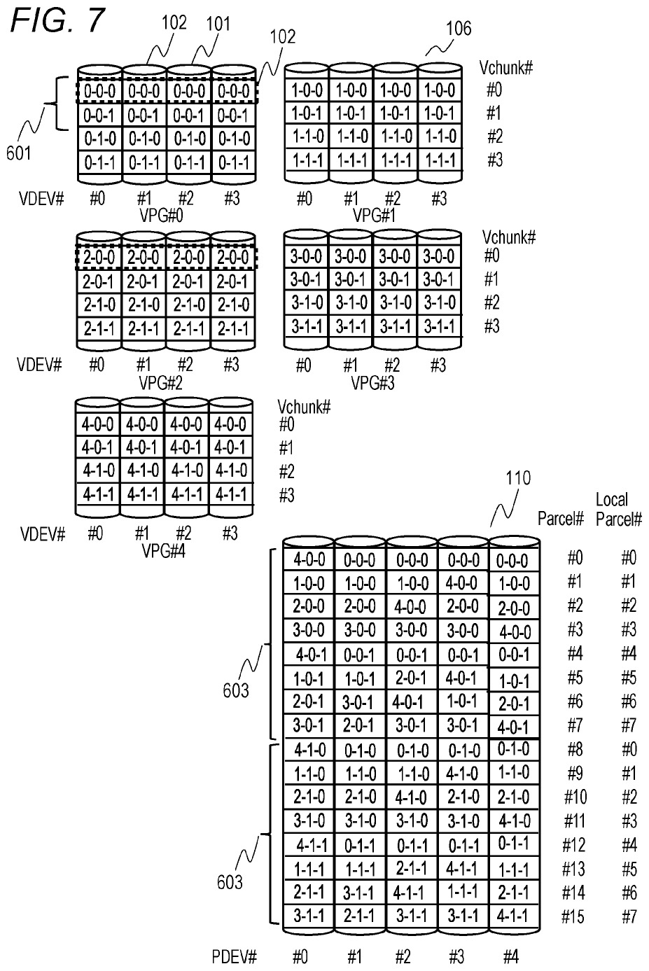

FIG. 7 illustrates an example of c=2, m=8, K=4, and N=5 for the parcel mapping 604 of the VPG 106 and the DPG 110. c is the number of Vchunks in the Vchunk period 601, m is the number of Parcels in the drive in the Parcel cycle 603, K is the number of drives in the VPG 106, and N is the number of drives in the DPG 110.

As described above, by repeatedly arranging the parcel mapping for each combination of the Vchunk period 601 and the Parcel cycle 603, the scale of the mapping pattern can be reduced, and a load of generation of the mapping pattern and a load of address transformation can be suppressed.

Among Vchunk identifiers “x-y-z” described on the virtual parcel 103 in the virtual device 102 of the VPG 106, x represents a VPG#, y represents a Vchunk period#, and Z represents a CVC#. The same Vchunk identifier is written to the physical parcel allocated to the virtual parcel 103. In the parcel mapping, correspondence between the plurality of virtual parcels 103 in one Vchunk period 601 and the plurality of physical parcels in one Parcel cycle 603 is referred to as a mapping pattern. For example, the mapping pattern is represented by using the Vchunk identifier and the VDEV# corresponding to each physical parcel in one Parcel cycle 603. The mapping pattern of each Parcel cycle 603 is common.

In this example, two Vchunk periods 601 and two Parcel cycles 603 are illustrated. Each Parcel cycle 603 spans 5 physical devices 107. All physical parcels in one Parcel cycle 603 are allocated to virtual parcels in one Vchunk period group.

In this case, m=8, but m may be an integral multiple of K in order to appropriately set the mapping between the VPG and the DPG in an arbitrary case where the number of physical devices 107 is not an integral multiple of K.

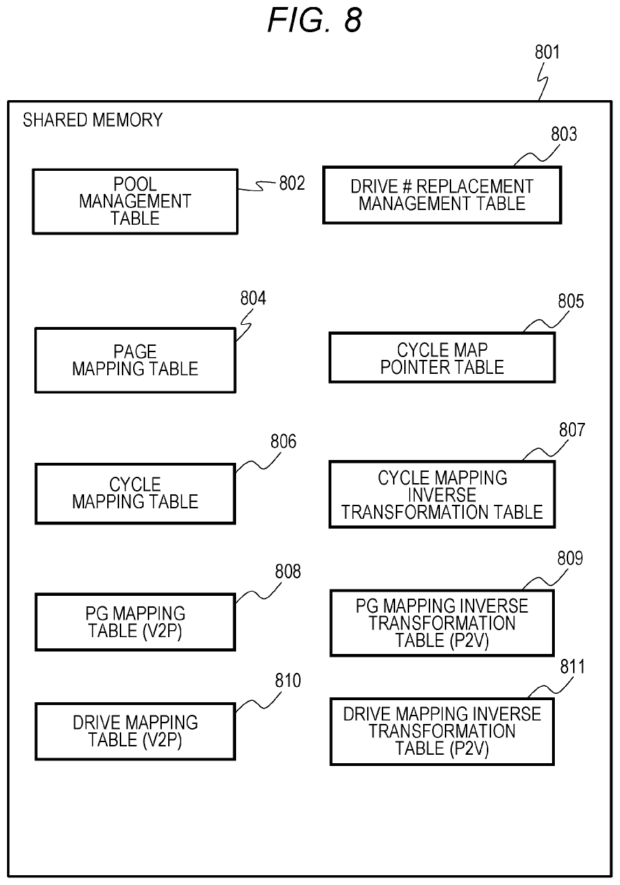

FIG. 8 illustrates content of the shared memory.

For example, a shared memory 801 is configured using at least one storage area of the physical device 107, the CM 214, and the LM 217. The storage controller 202 may configure the logical shared memory 801 using storage areas of a plurality of configurations in the physical device 107, the CM 214, and the LM 217, and execute cache management for various types of information.

The shared memory 801 stores a pool management table 802, a drive # replacement management table 803, a page mapping table 804, a cycle map pointer table 805, a cycle mapping table 806, a cycle mapping inverse transformation table 807, a PG mapping table (V2P) 808, a PG mapping inverse transformation table (P2V) 809, a drive mapping table (V2P) 810, and a drive mapping inverse transformation table (P2V) 811.

In the parcel mapping, the mapping pattern is represented by the PG mapping table 808, the cycle map pointer table 805, and the cycle mapping table 806.

When the drive is decreased, the mapping pattern before the decrease is referred to as a current mapping pattern (Current), the mapping pattern during the decrease is referred to as an intermediate mapping pattern (Changing), and the mapping pattern after the decrease is referred to as a target mapping pattern (Target). That is, during the decrease, the shared memory 801 stores the cycle mapping table 806 of the Current and the cycle mapping inverse transformation table 807 of the Current, the cycle mapping table 806 of the Changing and the cycle mapping inverse transformation table 807 of the Changing, and the cycle mapping table 806 of the Target and the cycle mapping inverse transformation table 807 of the Target. The PG mapping table 808 and the cycle map pointer table 805 may store a common table before and after the increase, but the configuration is not limited thereto.

In addition, during the decrease, the correspondence between the PDEV# and the Drive# is managed using the drive mapping table (V2P) 810, the drive mapping inverse transformation table (P2V) 811, and the drive# 803.

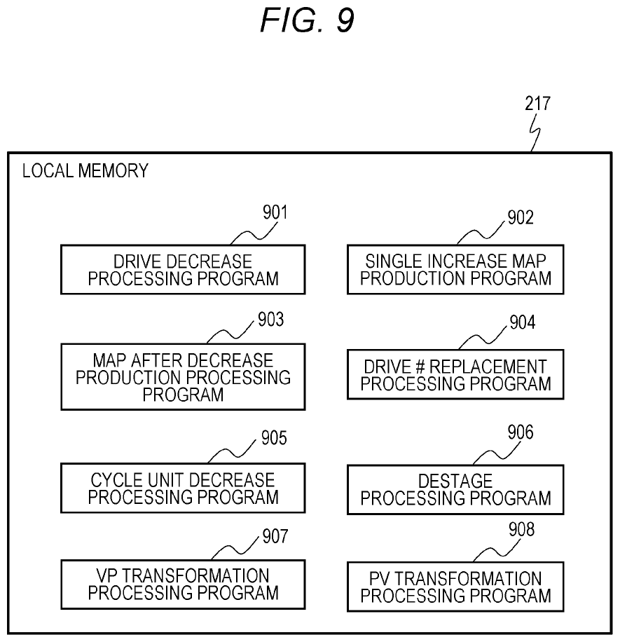

FIG. 9 illustrates contents of the local memory.

The local memory 217 stores a drive decrease processing program 901, a single increase map production program 902, a map after decrease production processing program 903, a cycle unit decrease processing program 905, a destage processing program 906, a VP transformation processing program 907, and a PV transformation processing program 908. A specific application of each processing will be described later.

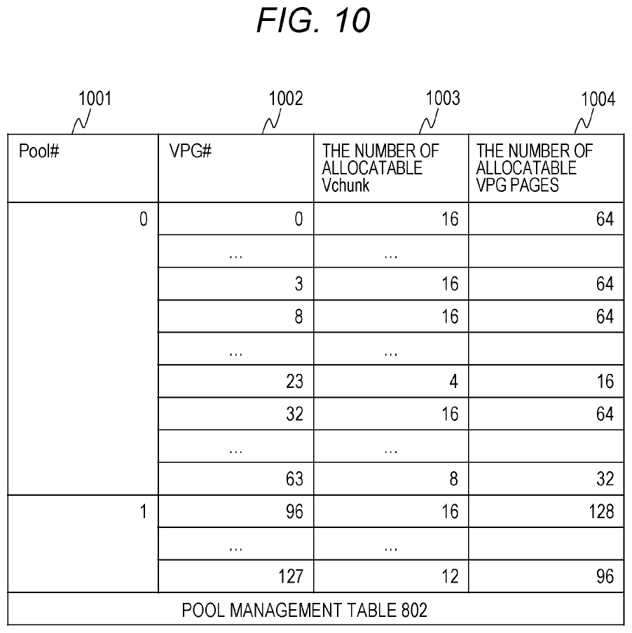

FIG. 10 illustrates a pool management table.

The pool management table 802 is information indicating a correspondence relationship between the pool 301 and the VPG 106. The pool management table 802 includes fields of a Pool# 1001, a VPG# 1002, the number of allocatable Vchunks 1003, and the number of allocatable VPG pages 1004.

With this table, the storage controller 202 can check the identifier of the VPG 106 belonging to the pool 301, the number of allocatable Vchunks of each VPG 106, and the number of allocatable VPG pages 1004 of each VPG 106.

A value greater than or equal to 0 is stored in the number of allocatable Vchunks 1003 based on the capacity of the corresponding DPG 110. In the VPG 106 indicated by the VPG# 1002, a page cannot be allocated to the Vchunk# exceeding the number of allocatable Vchunks 1003. When the number of period Parcels is m and when the number of Parcel cycles in the DPG is W, the maximum value V of the number of allocatable Vchunks 1003 is set according to the following criteria.

maximum value of the number of allocatable Vchunks V=W×m/K

At this point, because m is an integral multiple of K, the result of the above equation is always an integer.

m may not be a multiple of K when Parcel is separately reserved as a spare area within the Parcel cycle.

Assuming that the number of reserved parcels in the Parcel cycle is S, it is sufficient that m−s is a multiple of K, and the maximum value of the number of allocatable Vchunks 1003 in this case is set based on the following criteria.

maximum value of the number of allocatable Vchunks V=W×(m−s)/K

A value greater than or equal to 0 is stored in the number of allocatable VPG pages 1004 based on the capacity of the corresponding DPG 110. In the VPG 106 indicated by the VPG# 1002, a page cannot be allocated to the VPG page# exceeding the number of allocatable VPG pages 1004. As the number of allocatable Vchunks 1003V_c and the number of VPG pages in a Vchunk VP, the number of allocatable VPG pages P is set according to the following criteria.

The number of allocatable VPG pages P=V_c×VP

As is clear from the above formula, the number of allocatable VPG pages is proportional to the number of allocatable Vchunks 1003. In the following description, when it is simply described that the number of allocatable Vchunks 1003 is updated or deleted, the number of allocatable VPG pages 1004 is also updated unless otherwise specified. The number of allocatable VPG pages 1004 at the time of updating is obtained based on the above-described criteria.

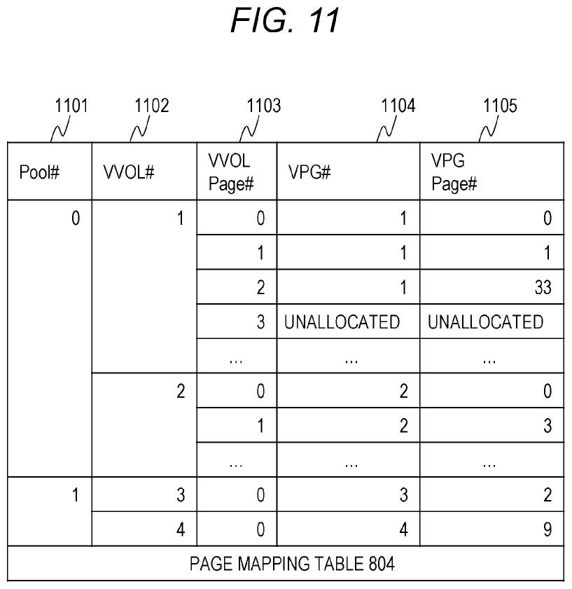

FIG. 11 illustrates a page mapping table.

The page mapping table 804 is information indicating a correspondence relationship between a page of the VVOL 302 and a page of the VPG 106. The page mapping table 804 includes fields of a pool# 1101, a VVOL# 1102, a VVOL page# 1103, a VPG# 1104, and a VPG page# 1105. The Pool# 1101, the VVOL# 1102, and the VVOL page# 1103 indicate the VVOL page. The VPG# 1104 and the VPG page# 1105 indicate the VPG page allocated to the VVOL page. A value corresponding to “unallocated” is stored in the VPG# 1104 and the VPG page# 1105 corresponding to the unused VVOL page# 1103.

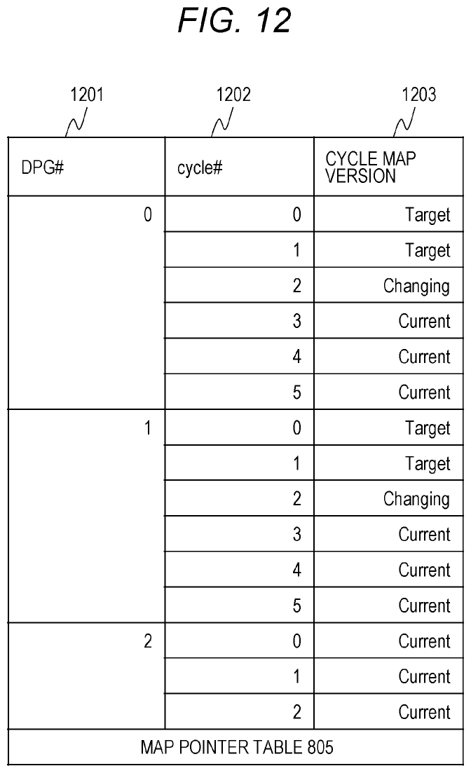

FIG. 12 illustrates a map pointer table. The map pointer table 805 includes fields of a DPG# 1201, a Cycle# 1202, and a cycle map version 1203. With this table, the storage controller 202 can refer to the version of the cycle mapping table to be referred to at the time of address transformation. The cycle map version 1203 is updated when a drive is increased. A cycle in which the cycle map version is “Target” indicates that the increase processing is completed. When accessing the address of the DPG space during the increase processing, the storage controller 202 executes the address transformation using the cycle mapping table after the increase when the cycle map version corresponding to the cycle of the designated DPG space is the “Target”, the storage controller 202 executes the address transformation using the cycle mapping table before the increase when the cycle map version is the “Current”, and the storage controller 202 executes the address transformation using the cycle mapping table during the increase when the cycle map version is the “Changing”.

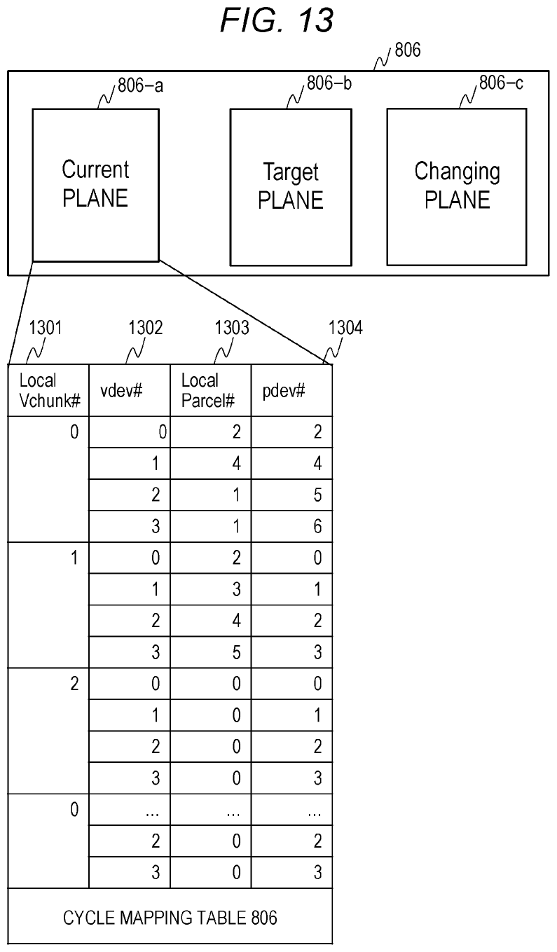

FIG. 13 illustrates the cycle mapping table. The cycle mapping table 806 includes three types of tables of the Current, the Target, and the Changing. These exist to refer to a correct address in the middle of the drive increase processing described below. The Current represents a current mapping table, the Target represents a target mapping table after the increase or decrease, and the Changing represents a mapping table during the transition of the increase or decrease. Each cycle mapping table 806 includes fields of a Cycle Vchunk# 1301, a VDEV# 1302, a Local Parcel# 1303, and a PDEV# 1304.

By referring to this mapping table, the storage controller 202 can acquire the Local Parcel# and the PDEV# using the CycleVchunk# and the VDEV# as keys.

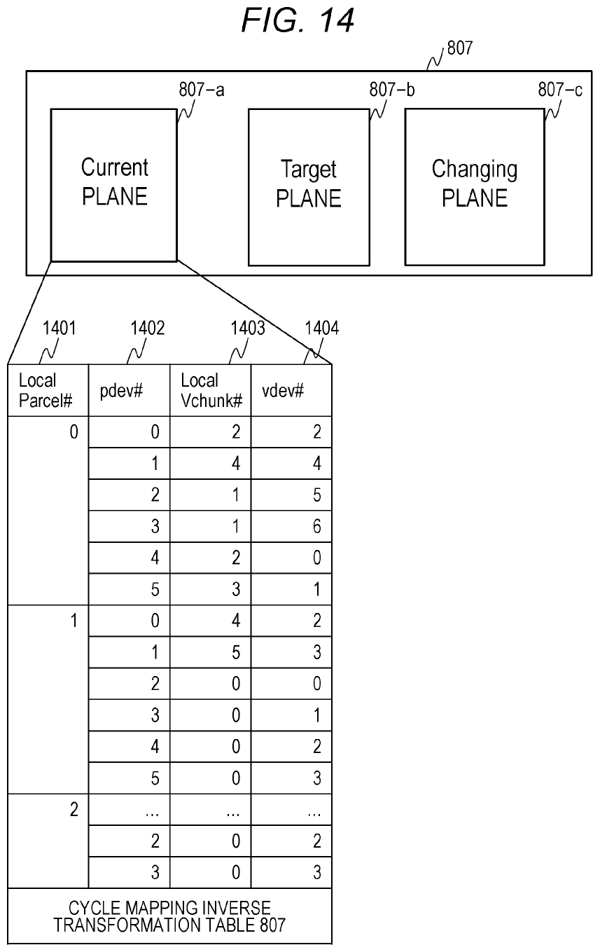

The cycle mapping inverse transformation table 807 in FIG. 14 is an inverse lookup table of the cycle mapping table 806, and includes two types of tables of the Current and the Target similarly to the cycle mapping table 806. The cycle mapping inverse transformation table 807 includes three types of tables of the Current, the Target, and the Changing. The Current of the cycle mapping inverse transformation table 807 is an inverse lookup table of the Current of the cycle mapping table 806, the Target of the cycle mapping inverse transformation table 807 is an inverse lookup table of the Target of the cycle mapping table 806, and the Changing of the cycle mapping inverse transformation table 807 is an inverse lookup table of the Changing of the cycle mapping table 806. Each cycle mapping inverse transformation table 807 includes fields of a Local Parcel# 1401, a PDEV# 1402, a Local Vchunk# 1403, and a VDEV# 1404. By referring to this mapping inverse transformation table, the storage controller 202 can acquire the Cycle Vchunk# and the VDEV# using the Local Parcel# and the PDEV# as keys.

This mapping inverse transformation table is updated in conjunction with the cycle mapping table 806. In the following description, when the cycle mapping table 806 is produced, updated, or deleted, or when the cycle mapping table 806 is set to a CURRENT plane, a Target plane, or a Changing plane, the cycle mapping inverse transformation table 807 is also produced, updated, or deleted in accordance with the cycle mapping table 806, or is set to the CURRENT plane, the Target plane, or the Changing plane unless otherwise specified.

A method for generating and referring to data of each cycle mapping table and the cycle mapping inverse transformation table will be described later.

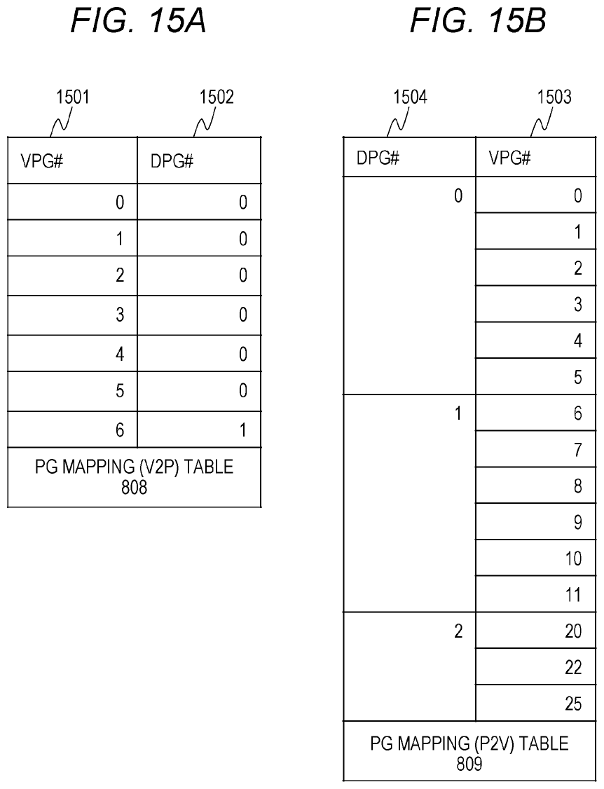

FIG. 15A illustrates a PG mapping (V2P) table. The PG mapping (V2P) table 809 is a table that manages the mapping between the VPG and the DPG. The PG mapping (V2P) table 808 includes a virtual parity group number (VPG#) 1501 and a distributed parity group number (DPG#) 1502.

In the PG mapping (V2P) table 808, the value of the distributed parity group number (DPG#) 1502 can be obtained from the virtual parity group number (VPG#) 1501.

The PG mapping (P2V) table in FIG. 15B is an inverse lookup table of the PG mapping (V2P) table 809. The PG mapping (P2V) table 809 includes a distributed parity group number (DPG#) 1504 and a virtual parity group number (VPG#) 1503.

In the PG mapping (P2V) table 809, the value of the virtual parity group number (VPG#) 1503 can be obtained from the distributed parity group number (DPG#) 1504.

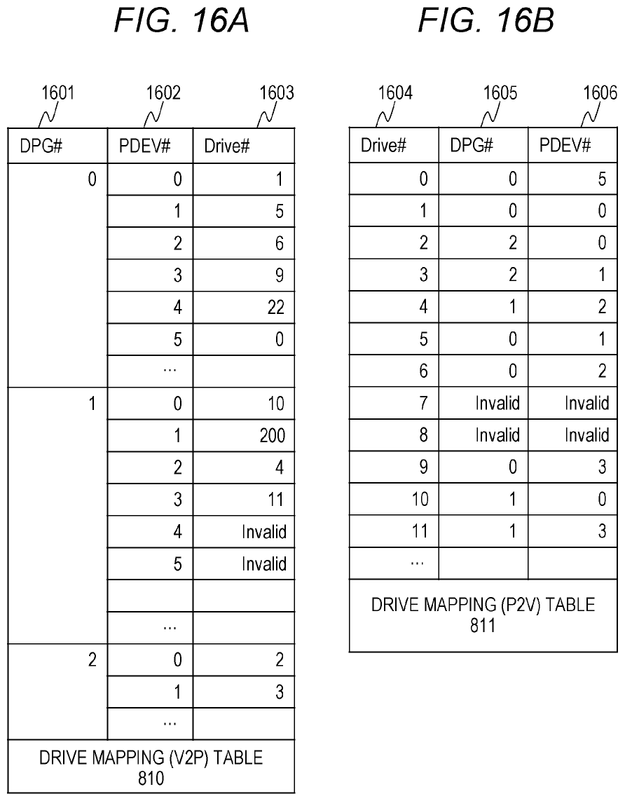

FIG. 16A illustrates a drive mapping (V2P) table. The drive mapping (V2P) table 810 is a table that manages the mapping between the PDEV# and the Drive#. The drive mapping (V2P) table 810 includes a distributed parity group number (DPG#) 1601, a PDEV# 1602, and a Drive# 1603. In the drive mapping (V2P) table 810, the value of the Drive# 1603 can be obtained from the distributed parity group number (DPG#) 1601 and the PDEV# 1602.

The drive mapping (P2V) table in FIG. 16B is an inverse lookup table of the drive mapping (V2P) table 811. The drive mapping (P2V) table 811 includes a Drive# 1606, a distributed parity group number (DPG#) 1604, and a PDEV# 1605. In the drive mapping (P2V) table 811, the values of the distributed parity group number (DPG#) 1604 and the PDEV# 1605 can be obtained from the Drive# 1606.

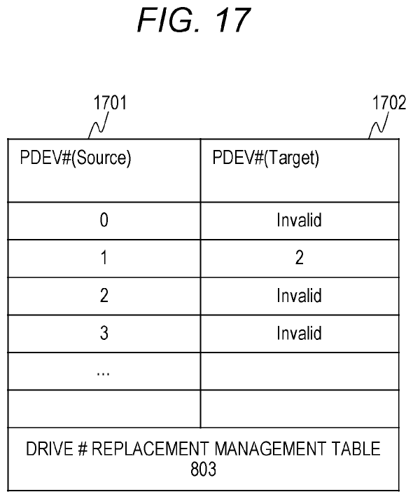

FIG. 17 illustrates the drive # replacement management table 803. The drive # replacement management table 803 includes a PDEV# (Source) 1701 and a PDEV# (Target) 1702. The value of the PDEV# (Target) 1702 of the drive # replacement destination can be obtained from the PDEV# (Source) 1701.

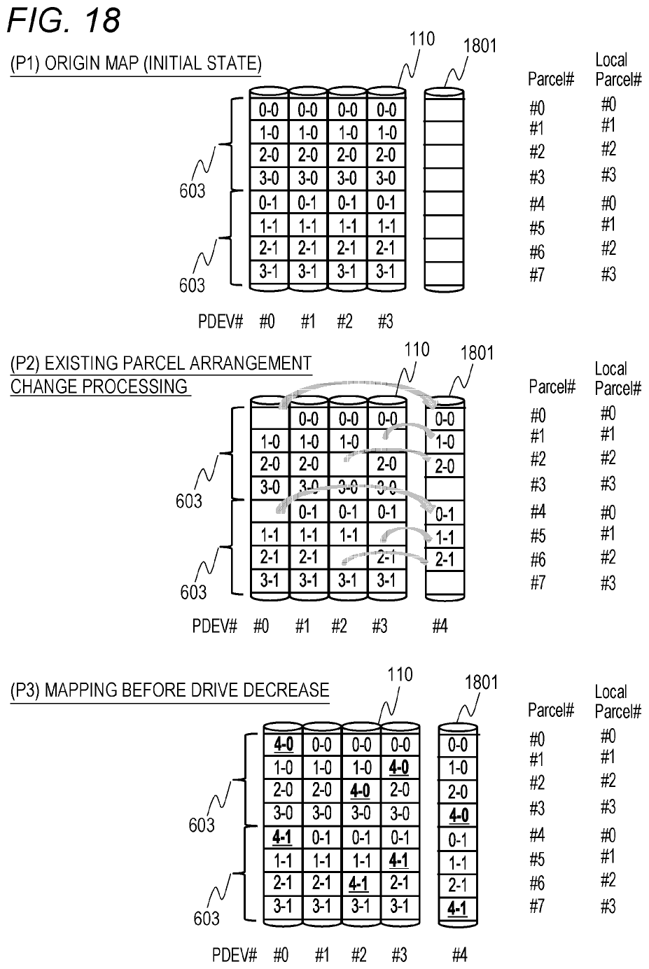

FIG. 18 illustrates a mapping pattern producing method before drive decrease illustrated in the first embodiment.

In this case, the mapping pattern in which the number of drives is 5 is illustrated in a configuration in which the number of period Parcel m is 4 and the number of drives N is 4.

The mapping pattern is produced assuming that one drive is increased based on a configuration in which the number of period Parcels m is 4 and the number of drives N is 4.

P1 indicates an initial mapping pattern before the drive increase. The example in FIG. 18 illustrates only two Parcel cycles 603 for simplicity.

Among the Vchunk identifiers “x-y” described on the physical parcels 109 in the physical devices 107 in the DPG 110, x represents the LVC# of the corresponding virtual parcel 103 and y represents the Vchunk period#.

P2 indicates a mapping pattern during the drive increase. A part of the Parcel 108 constituting the existing Vchunk 101 is allocated to an increase drive 1801. Thus, a Parcel that is not mapped in the Vchunk 101 can be generated in the existing physical device 107. In the example of FIG. 18, the Parcel 108 that moves by one Parcel is selected from three of four physical devices 107 per Parcel cycle, and a total of three Parcels are moved per Parcel cycle. However, the moving amount depends on the number of period Parcel, the number of reserved parcels in the period Parcel, and the number of Parcels constituting the Vchunk. As the number of period Parcels m, the number of reserved parcels S in the period Parcel, and the number of VPG drives K, a moving amount T per Parcel cycle is expressed by the following equation.

T=(K−1)×(m−s)/K

In P3, a new Vchunk is produced. The new Vchunk includes the Parcel that is not mapped to the Vchunk and is generated by the reconfiguration processing of the existing Vchunk.

The number of new Vchunks per Parcel cycle depends on the number of period Parcel, the number of reserved parcels in the period Parcel, and the number of Parcels constituting the Vchunk. As the number of period Parcel m, the number of reserved parcels S in the period Parcel, and the number of VPG drives K, the number of new Vchunks V is expressed by the following equation.

V=(m−s)/K

The capacity (=V×K) of the new Vchunk is equal to the capacity (=m−s) of the increase drive 1801 excluding the spare.

The mapping pattern in the configuration with the number of period Parcels m=4 and the number of drives N=5 is set using the mapping pattern determined by the above procedure. The mapping pattern may be performed by actually increasing one drive to the distributed RAID of N=4, or the distributed RAID of N=5 may be produced and used.

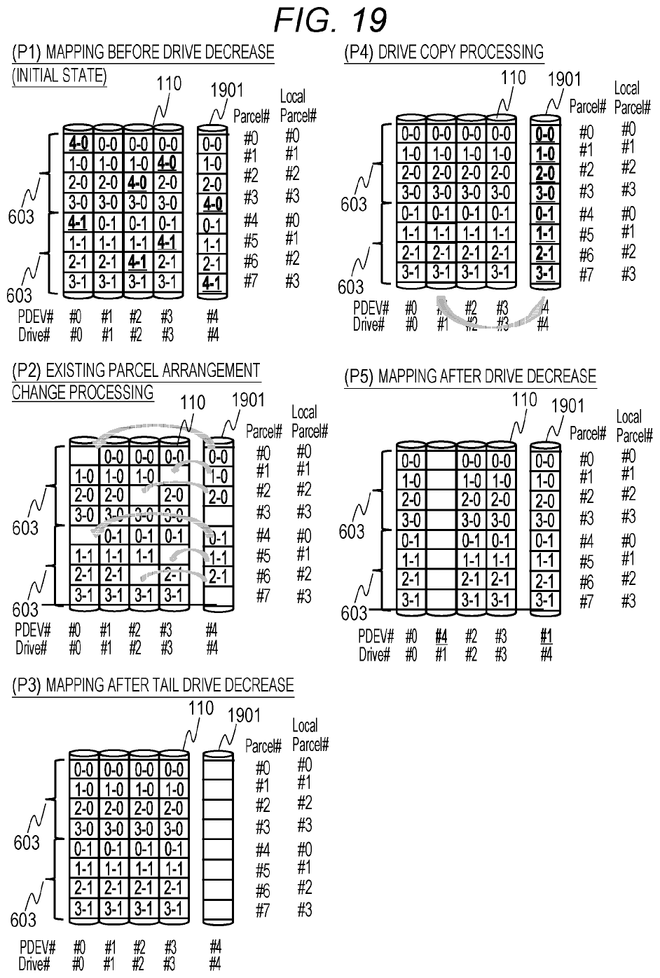

FIG. 19 illustrates a mapping pattern producing method after the drive decrease illustrated in the first embodiment.

In this case, a method for decreasing the number of drives of Drive# 1 using the mapping pattern of the number of drives=5 in the configuration of the number of the period Parcel number m=4 and the number of drives N=4 will be described.

P1 indicates the current mapping pattern that is an initial mapping pattern before the drive decrease. The example in FIG. 18 illustrates only two Parcel cycles 603 for simplicity.

The allocated VVOL page is moved from the Vchunk specified by the Vchunk identifier “4-a” (a is a positive integer) to another Vchunk, and the valid data is not stored in the Vchunk. That is, all the VVOLPages allocated to the VPG# 4 are moved to the unallocated pages of other VPG#, and all the pages on the VPG# 4 are set to be unallocated. Subsequently, the Vchunk specified by the Vchunk identifier “4-a” (a is a positive integer) is deleted.

In P2, data is moved from the Parcel on the largest drive (the PDEV# 4 in this example, and hereinafter, referred to as a tail drive 1901) of the PDEV# to the Parcel that becomes unallocated by the decrease of the Vchunk specified by the Vchunk identifier “4-a” (a is a positive integer). The Parcel arrangement after the movement is determined based on the mapping pattern of N=4.

P3 indicates mapping after Parcel replacement. By replacing Parcel, all the pieces of data on the tail drive 1901 is lost.

At P4, the data is copied from the drive (Drive# 1) of the decrease target to the tail drive 1901.

At P5, the drive mapping table is updated such that the PDEV# (#1) of the drive of the decrease target becomes the Drive# (Drive# 4) of the tail drive 1901 and such that the PDEV# (#4) of the tail drive 1901 becomes the Drive# (Drive# 1) of the drive of the decrease target.

As described above, the drive indicated by the Drive# 1 is out of the range of the mapping pattern and the state in which the valid data does not exist on the Drive can be implemented, so that the Drive can be decreased.

Details of the operation of the storage controller 202 will be described below.

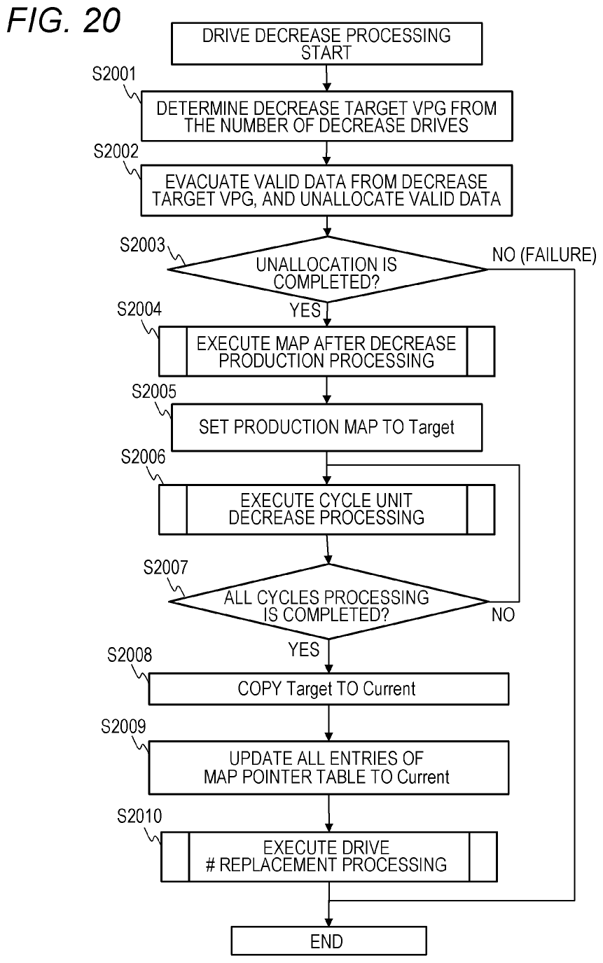

FIG. 20 illustrates drive decrease processing. The drive decrease processing program 901 executes the decrease processing when the drive is decreased. The administrator selects at least one drive for the decrease for the system, and inputs a decrease instruction to the management server 203. The storage controller 202 executes the drive decrease processing of opportunity of receiving the decrease instruction from the management server 203.

The drive decrease processing program 901 determines the VPG# that becomes the operation target from the number of drives designated as decrease targets (step S2001).

The VPG# is determined in the following procedure. By referring to the drive mapping (P2V) table 811, the DPG# corresponding to the Drive# instructed to be decreased is specified. At this point, there are the case where the single DPG# is obtained from a plurality of decrease target Drive #s and the case where the plurality of decrease target Drive #s are divided into the plurality of DPG #s.

When there is the plurality of corresponding DPG #s, the subsequent pieces of processing are repeatedly executed on each DPG#. Hereinafter, the target DPG is referred to as a decrease target DPG.

Subsequently, a list of VPG Ifs corresponding to the DPG# is acquired with reference to the PG mapping (P2V) table 809. R (R is the number of decrease target drives corresponding to the single DPG#) VPGs in descending order of the acquired VPG# are set to the operation target. Hereinafter, the VPG of the operation target is referred to as a decrease target VPG.

Subsequently, the valid data is evacuated from the VPG of the decrease target (step S2002). The valid data is evacuated in the following procedure.

In the pool management table 802, the number of allocatable Vchunks 1003 corresponding to the decrease target VPG# and the number of allocatable VPG pages 1004 are updated to 0. Thus, the valid data is prevented from being additionally stored in the VPG thereafter.

Subsequently, a list of VVOL Page #s allocated to the VPG# of the decrease target is acquired by referring to the page mapping table 804. These pages are the evacuation source data.

Subsequently, the page of the evacuation destination is determined. By referring to the pool management table 802, the VPG# that corresponds to the same pool# as the VPG# of the decrease target and is not a decrease target and in which the number of allocatable VPG pages 1004 is not 0 is determined as the evacuation destination. When a plurality of candidates exist, for example, the VPG having the lowest utilization rate is selected as the target VPG, or the allocation priority is set to the VPG for each VVOL, the VPG having the highest allocation priority is selected as the target VPG, and the VPG page is selected as the evacuation destination. As a method for selecting the target VPG page, for example, a page having the smallest VPG page# among free pages in the target VPG is selected as the target VPG page.

This processing is repeated for the number of pages of the evacuation source data.

When only the smaller number of pages than the evacuation source page can be secured, because the drive decrease processing cannot be continued, the drive decrease processing program 901 is ended as a failure (No in Step S2003).

When the page can be secured for the number of evacuation source pages, the data of the evacuation source page is copied to the evacuation destination page. When the copy is completed, the entry of the VPG Page# 1105 of the page mapping table 804 is updated from the VPG# and the VPG Page# of the copy source page to the VPG# and the VPG Page# of the copy destination page. In addition, the values of the entries of the number of allocatable VPG pages 1004 and the number of allocatable Vchunks 1003 for each VPG change due to copying, so that the information about the pool management table 802 is also updated. After the update, the drive decrease processing program 901 executes the next step (Yes in Step S2003).

Subsequently, the drive decrease processing program 901 executes map after decrease production processing (step S2004). In this processing, the mapping pattern after the decrease is generated. Details will be described later.

Subsequently, the drive decrease processing program 901 sets the produced mapping pattern after the decrease to the cycle mapping table of the Target plane of the cycle mapping table 806 (step S2005).

Subsequently, the drive decrease processing program 901 determines whether the cycle unit decrease processing is completed for all cycles (step S2007).

For example, the map pointer table 805 may be referred to in the determination. When all cycle map version entries 1203 corresponding to the decrease target DPG# become the state of referring to Target, it can be considered that the cycle unit decrease processing is completed.

When the cycle unit decrease processing is not completed for all the cycles (No in step S2007), the drive decrease processing program 901 returns to step S2006 and executes similar processing on the next target drive. When the cycle unit decrease processing is completed for all the cycles (Yes in step S2007), the cycle mapping table 806 of the CURRENT plane is updated to the contents of the cycle mapping table of the Target plane (step S2008). Thus, the CURRENT plane and the Target plane are matched with each other in the content of the mapping pattern after the decrease.

Subsequently, the drive decrease processing program 901 refers to the map pointer table 805, updates all the cycle map version entries 1203 corresponding to the decrease target DPG# to all the Currents, and completes the processing (step S2009). Thus, even when the above-described processing is executed again to update the Target plane during the next new drive decrease, the current mapping pattern can be continuously referred to.

In the above processing, the valid data is removed from the R tail drives corresponding to the number of decreased drives (a state P3 in FIG. 19).

Subsequently, the drive decrease processing program 901 executes the drive # replacement processing, and the decrease processing is completed (step S2010). By this processing, the valid data is removed from the drive of the decrease target, and the drive can be decreased. Details will be described later.

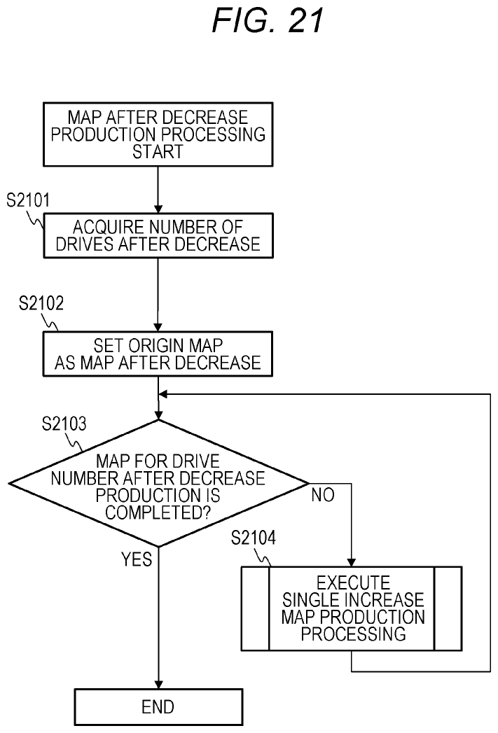

FIG. 21 illustrates map after decrease production processing. The map after decrease production processing program 903 calculates the number of drives after the decrease (step S2101). The number of drives after the decrease is counted as the number of valid Drive #s, namely, the number of non-invalid Drive #s among the entries of Drive# 1603 corresponding to the decrease target DPG# 2 in the drive mapping (V2P) table 810. This is the number of drives (Q) constituting the target DPG#. The number of drives after the decrease is obtained by Q−R.

Subsequently, the map after decrease production processing program 903 produces a map (origin map) that becomes an origin point of map production, and sets the map to a map after decrease (step S2102). The origin map is a mapping pattern in the minimum number of drives that can configure the DPG. In the example of FIG. 18, the mapping of four drives indicated by P1 corresponds to the mapping. In FIG. 18, the case of K=4 is illustrated, and the number of drives constituting the DPG is not less than four, so that the origin map becomes the map of the number of drives four.

A map in which the number of drives is more than four may be used as the origin map. However, the number of drives less than the number of origin maps cannot be decreased.

A method for producing the origin map is not limited. For example, as indicated by P1 in FIG. 18, the Vchunks may be allocated in order from the head of the PDEV.

When the number of drives in the map after decrease is less than the number of drives after decrease (No in Step S2103), the map after decrease production processing program 903 executes single increase map production processing (step S2104). Details will be described later. The map after decrease in which the number of drives is increased is produced by the single increase map production processing.

When the number of drives in the map after decrease is matched with the number of drives after decrease (Yes in Step S2103), the map after decrease production processing program 903 ends the processing. The map after decrease is created by the above procedure.

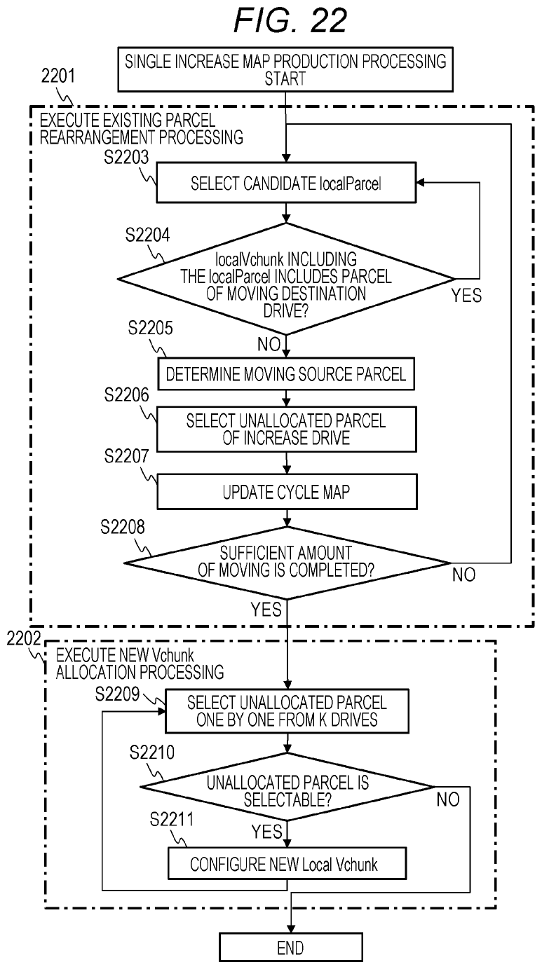

FIG. 22 illustrates the single increase map production processing. The single increase map production processing largely includes existing parcel rearrangement processing 2201 of updating the parcel information configuring the existing Vchunk and new Vchunk allocation processing 2202 of newly allocating the Vchunk to the increased capacity. Each pieces of processing will be described separately.

In the existing parcel rearrangement processing 2201, the single increase map production program 902 changes some of the existing Vchunks configured by the physical parcels 109 in the physical devices 107 associated by the map after decrease to a configuration in which the number of drives is added by one. That is, the configuration is changed to the configuration using the physical parcel of the increase drive 1801, and the cycle mapping table 806 is updated.

The single increase map production program 902 selects one physical parcel 109 allocated to the existing Local Vchunk as a moving source candidate, and acquires the Local Parcel# and the PDEV# of the parcel (step S2203). The Local Parcel# and the PDEV# may be directly selected, or the corresponding Local Parcel# and PDEV# may be acquired with reference to the cycle mapping table 806 after the target Local Vchunk# and VDEV# are determined. In this case, for example, in the single increase map production processing, the number of parcels selected as a moving source is selected so as to be leveled among the existing PDEVs. Hereinafter, the selected physical parcel 109 is referred to as a candidate parcel.

Subsequently, the single increase map production program 902 determines whether the Local Vchunk including the candidate parcel includes the Parcel in the increase drive (step S2204). The single increase map production program 902 refers to the cycle mapping inverse transformation table 807 of the Target, and acquires the Local Vchunk# using the Local Parcel# and the PDEV# of the candidate parcel acquired in step S2203 as keys. Subsequently, the single increase map production program 902 refers to the cycle mapping table 806 of the Target, and acquires all the VDEV #s constituting the Local Vchunk# and the PDEVs# of the Parcel corresponding to the Local Vchunk# and the VDEV# using the Local Vchunk# as a key. When at least one of the acquired PDEV #s is matched with the PDEV# of the increase drive, the processing branches to Yes in step S2204, and executes step S2203 again.

When all the acquired PDEV Ifs are not matched with the PDEV# of the increase drive (No in step S2204), the single increase map production program 902 determines the candidate parcel as the moving source parcel (step S2205).

Subsequently, the single increase map production program 902 selects an unallocated parcel to the cycle mapping table 806 from the physical Parcel of the increase drive, and determines the selected parcel as a moving destination parcel (step S2206). Means for determining whether the parcel is unallocated is not particularly limited. For example, the determination may be made using a table that manages the allocated or unallocated state for each parcel#, or the unallocated parcels may be acquired by managing the unallocated parcels# in a queue and referring to the queue.

Subsequently, the single increase map production program 902 updates the configuration information about the Vchunk including the moving source parcel to include the moving destination parcel (step S2207). The single increase map production program 902 refers to the cycle mapping inverse transformation table 807 of the Target, and acquires the Local Vchunk# and the VDEV# using the Local Parcel# and the PDEV# of the moving source as keys. Subsequently, Local Parcel# entry 1303 and PDEV# entry 1304 that can be acquired using the acquired Local Vchunk# and VDEV# as keys are updated to the Local PDEV# and PDEV# of the moving destination parcel, respectively. Furthermore, the single increase map production program 902 updates the cycle mapping inverse transformation table 807 of the Target in accordance with the cycle mapping table 806. At this point, since the moving source parcel no longer configures the Local Vchunk, invalid values are stored in the Local Vchunk# 1403 and the VDEV# that can be acquired using the Local Parcel# and the PDEV# of the moving source parcel as keys.

Subsequently, the single increase map production program 902 determines whether a sufficient amount of moving of the existing parcel is executed (step S2208). When the number of parcels moved to the increase drive is less than the moving amount T (No in step S2208), the single increase map production program 902 returns to step S2203 to execute the processing.

When the number of parcels moved to the increase drive is larger than or equal to the moving amount T (Yes in step S2208), the single increase map production program 902 advances the processing to the new Vchunk allocation processing 2202.

In the new Vchunk allocation processing 2202, first the single increase map production program 902 attempts to select the unallocated physical parcel one by one from the K drives (step S2209).

When the unallocated physical parcel is selectable (Yes in step S2210), the single increase map production program 902 configures the new Vchunk with the selected K Parcels (step S2211). The single increase map production program 902 adds the new Local Vchunk# entry to the cycle mapping table 806 of the Target, and sets the Local Parcel# and the PDEV# of the selected K parcels for the K VDEVs# constituting the new Local Vchunk#. The cycle mapping inverse transformation table 807 of the Target is also updated in accordance with the cycle mapping table 806. A method for selecting the K drives is not particularly limited, and for example, the K drives may be selected from those having the larger number of unallocated parcels.

When the new Vchunk is configured, the VPG# to which the Vchunk is allocated is uniquely determined. The VPG# of the allocated target and the Cycle Vchunk# in the VPG are obtained by the following equation.

VPG#=Floor (LVC#/C)

Cycle Vchunk#=LVC# mod C

When the K parcels cannot be selected (No in step S2210), the single increase map production program 902 ends the processing.

As described above, the mapping pattern constituting the

Vchunk is produced using one more drive than the number of drives of the original mapping pattern. In the first embodiment, a subject of the single increase map production processing is described as the single increase map production program 902 in the storage controller 202, but a part or all of the unit increase map production processing may be executed by another subject. For example, the mapping pattern according to the configuration may be previously produced by a high-performance computer, and the storage controller 202 may read and use the produced mapping pattern. Thus, a load on the storage controller 202 can be reduced, and the mapping pattern with a better characteristic can be used.

In this case, for example, the previously-produced mapping pattern is stored on the shared memory 801 or the local memory 217 for each number of configuration PDEVs, and the mapping pattern corresponding to the number of configuration PDEVs after decrease is set on a Target plane 806B of the cycle mapping table 806 instead of steps S2004 to S2005 in FIG. 20.

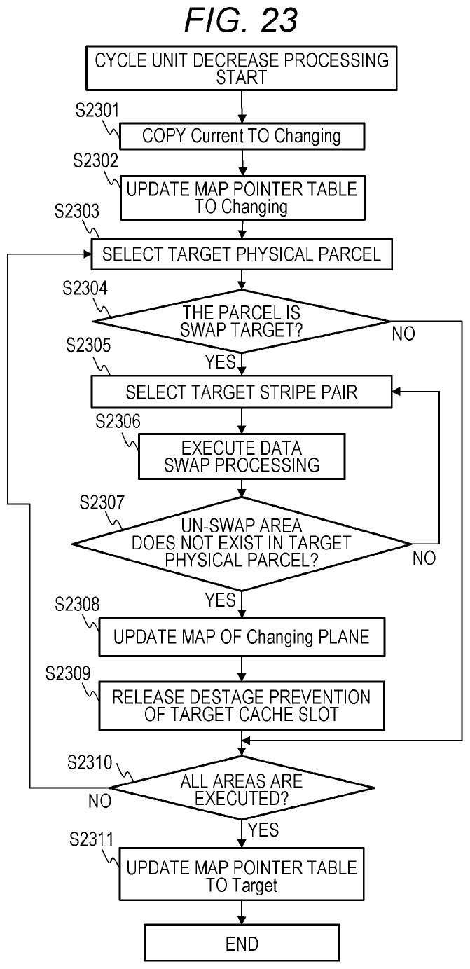

FIG. 23 illustrates cycle unit decrease processing.

The cycle unit decrease processing program 905 executes the processing in step S2006 of the drive decrease processing described above. In the cycle unit decrease processing, the arrangement of the data indicated by the current mapping pattern (Current) is changed to the arrangement of the data indicated by the target mapping pattern (Target) by executing data SWAP processing (described later).

The cycle unit decrease processing program 905 copies a Current plane of the cycle mapping table 806 to the Changing plane (step S2301), and updates the cycle map version entry of the cycle in the map pointer table 805 to the Changing (step S2302).

Subsequently, the cycle unit decrease processing program 905 sequentially selects one physical parcel in the cycle mapping table 806 of the decrease target as a target physical parcel (step S2303). For example, the cycle unit decrease processing program 905 may select the physical parcels for which the data SWAP processing is executed as the target physical parcels in ascending order of the PDEV# and the Parcel# among the physical parcels in all the drives in the cycle mapping table 806.

Subsequently, the cycle unit decrease processing program 905 determines whether the target physical parcel is a SWAP target (step S2304). Specifically, when there is a difference between the Local Vchunk# and VDEV# configured by the target physical parcel with reference to the Current plane of the cycle mapping inverse transformation table 807 referred to by the DPG of the decrease target, the target physical parcel is a SWAP target. At this point, sometimes there is no valid entry in the Local Vchunk# and the VDEV#. Because it indicates that the Parcel is not stored after the decrease, the Parcel is not subjected to SWAP.

Furthermore, the physical parcels acquired by referring to the Target plane using the Local Vchunk# and VDEV# configured by the SWAP target physical parcel on the Current plane as keys become a SWAP destination pair.

When it is determined that the target physical parcel is not the SWAP target (No in step S2304), the cycle unit decrease processing program 905 advances the processing to step S2310. Step S2310 will be described later.

When it is determined that the target physical parcel is the SWAP target (Yes in step S2304), the cycle unit decrease processing program 905 selects two Vchunks to which the SWAP target pair is allocated as the target Vchunk pair, and sequentially selects the virtual stripe in the target Vchunk pair as the target stripe pair (step S2305).

Subsequently, the cycle unit decrease processing program 905 executes data SWAP processing on the target stripe pair (step S2306). The data SWAP processing is similar to the processing described in International Publication No. 2014/115320. In the data SWAP processing, when at least one of the target stripe pair stores the valid data, the data is exchanged between the target stripe pairs. For example, in the data SWAP processing, when at least one virtual stripe of the target stripe pair is allocated to the VVOL page, the data is staged from the physical stripe corresponding to the virtual stripe in the Current to the target cache slot corresponding to the VVOL page, prevents the destage of the target cache slot (writing from the CM 214 to the physical device 107), and sets the target cache slot to dirty. When destage prevention is released after the data SWAP processing, the data stored in the target cache slot is asynchronously destaged to the physical stripe corresponding to the virtual stripe at the Target.

Subsequently, the cycle unit decrease processing program 905 determines whether a stripe (un-SWAP area) that is not subjected to the data SWAP processing exists in the target physical parcel (step S2307). When the un-SWAP area exists (No in step S2307), the cycle unit decrease processing program 905 returns to step S2303, and executes similar processing on the next physical stripe in the target physical parcel.

When it is determined that the un-SWAP area exists (Yes in step S2307), the cycle unit decrease processing program 905 updates the information about the cycle mapping table 806 of the Changing plane to parcel information after the SWAP (step S2308). Thus, even when the VP transformation processing (described later) is executed on the cycle# of the cycle unit decrease processing target, the correct physical parcel can be accessed.

Subsequently, the cycle unit decrease processing program 905 cancels the destage prevention of the target cache slot to which the destage prevention is executed in step S2306 (step S2309).

Subsequently, the cycle unit decrease processing program 905 determines whether all the physical parcels in the cycle mapping table 806 of the decrease target is selected as the target physical parcel (step S2310). When the unselected physical parcel exists (No in step S2310), the cycle unit decrease processing program 905 returns to step S2303, and selects the next target physical parcel.

When the unselected physical parcel does not exist (Yes in step S2310), the cycle unit decrease processing program 905 updates the cycle map version entry of the cycle in the map pointer table 805 to the Target, and ends the processing (step S2311).

According to the above cycle unit decrease processing, when valid data is stored in the Vchunk corresponding to the physical parcel of the SWAP target, the storage controller 202 reads the valid data from the physical parcel corresponding to the Vchunk based on the Current, and writes the valid data to the physical parcel corresponding to the Vchunk based on the Target. Thus, the storage controller 202 can move the data according to the change of the mapping pattern from the Current to the Target.

In the cycle unit decrease processing, the storage controller 202 may sequentially select the virtual chunk and the virtual parcel instead of sequentially selecting the physical parcel.

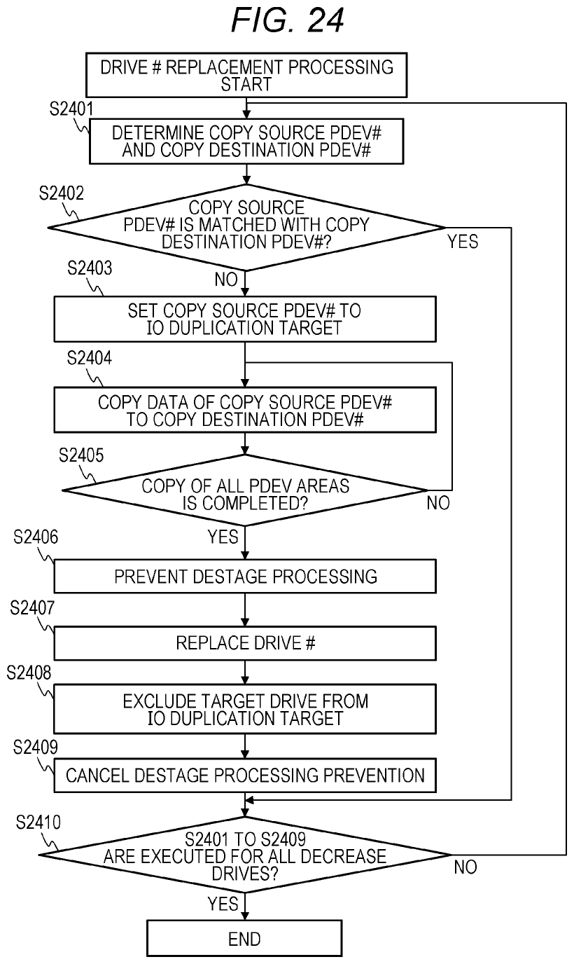

FIG. 24 illustrates drive If replacement processing.

The drive # replacement processing program 904 executes the processing in step S2010 of the drive decrease processing described above. In this process, first the data is copied from the decrease target drive to the tail drive. Thus, the data in the tail drive and the data in the decrease target drive are matched with each other.

In this state, by replacing the PDEV# of the decrease target drive and the PDEV# of the tail drive with the Drive# of the tail drive and the Drive# of the decrease target drive on the drive mapping table, respectively, the PDEV# of the decrease target drive becomes the tail drive and becomes the PDEV# out of the range of the mapping pattern. Thereafter, because the data is not accessed to the decrease target drive, the drive can be decreased.

The drive # replacement processing program 904 determines the PDEV# of the decrease target drive as the copy source PDEV#, and determines the PDEV# of the tail drive as the copy destination PDEV# (step S2401).

When a plurality of drives is collectively decreased, there is a plurality of copy source drives, but an arbitrary one is selected. The tail drive refers to the drive mapping (V2P) table 810 and is set to the maximum PDEV# in which the valid value (not invalid) is stored in the Drive# among the PDEVs# corresponding to the decrease target DPG#.

When the copy source PDEV# and the copy destination PDEV# is matched with each other (Yes in step S2402), the subsequent copy processing is unnecessary, and thus step S2410 is executed.

When the copy source PDEV# and the copy destination PDEV# is not matched with each other (No in step S2402), the drive # replacement processing program 904 manages the copy source PDEV# as an IO duplication target (step S2403). The drive # replacement processing program sets the copy source PDEV# to the PDEV# (Target) 1702 corresponding to the PDEV# (Source) 1701 indicating the copy source PDEV# in the drive # replacement management table 803. Thus, in the destage processing (described later), when the drive of the destage target is the copy source PDEV, the destage processing is also executed on the copy destination PDEV.

Subsequently, the drive # replacement processing program 904 copies the data on the copy source PDEV to the copy destination PDEV (step S2404). When the copy of all the PDEV areas is completed (step S2405), the processing proceeds to step S2406.

In step S2406, the drive # replacement processing program 904 prevents the destage processing from being executed. The destage processing is processing of writing the data on the cache in the drive. The prevention method is not limited. For example, prevention management information is held in a memory, the management information is referred to each time destage processing is executed, and the management information is prevented. In this case, the processing can be skipped.

Subsequently, the drive # replacement processing program 904 replaces the drive# (step S2407). In the drive mapping (V2P) table 810, the Drive# of the tail drive is set to the entry of the Drive# 1603 corresponding to the DPG# and PDEV# of the decrease target, and the Drive# of the decrease target drive is set to the entry of the Drive# 1603 corresponding to the DPG# and PDEV# of the tail drive. The contents of the drive mapping (P2V) table 811 are updated so as to be matched with the correspondence of the drive mapping (V2P) table 810.

Subsequently, the drive # replacement processing program 904 excludes the target drive from the IO duplication target (step S2408). The drive # replacement processing program sets the invalid value (Invalid) to the PDEV# (Target) 1702 corresponding to the PDEV# (Source) 1701 indicating the copy source PDEV# in the drive # replacement management table 803. Thus, in the subsequent destage processing, the destage to the copy destination PDEV# is not executed.

Subsequently, the drive If replacement processing program 904 cancels the destage processing prevention executed in step S2406 (step S2409).

The drive # replacement processing program 904 ends the processing (Yes in step S2410) when steps S2401 to S2409 are executed for all the decrease target drives, and the processing is executed again from step S2401 (No in Step S2410) when the unexecuted decrease target drive exists.

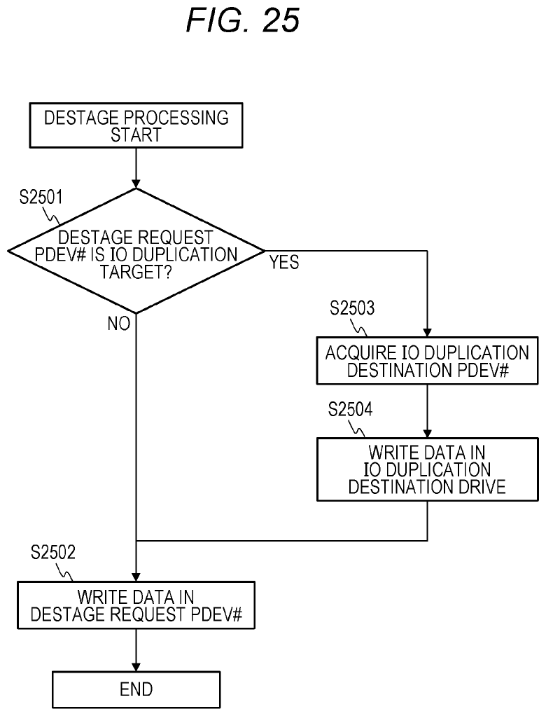

FIG. 25 illustrates destage processing. The destage processing is processing of writing the data on the cache in the drive. For example, the destage processing is executed in discarding the data from the cache when a free space storing the new data does not exist on the cache.

In the destage processing, the destage processing program 906 checks whether the PDEV# indicating the drive of the destage target is the IO duplication target, namely, refers to the drive # replacement management table 803 to check whether the valid value exists in the PDEV# (Target) 1702 for the PDEV# indicating the drive of the destage target.

When the valid value does not exist (No in step S2501), the requested data is written in the PDEV# indicating the drive of the destage target, and the processing is ended (step S2502).

When the valid value exists (Yes in step S2501), the PDEV# stored in the PDEV# (Target) 1702 is acquired as the PDEV# of the IO duplication destination (step S2503), and the data is written to the IO duplication destination drive (S2504). The requested data is written to the PDEV# indicating the drive of the destage target, and the processing is ended (step S2502).

Thus, the destage processing to the PDEV# of the IO duplication target is also destaged to the duplication destination PDEV#, and the data update executed during the drive copy is also reflected to the copy destination drive.

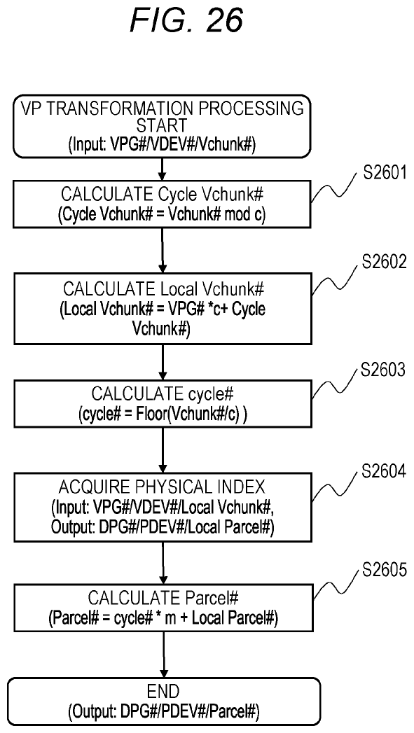

FIG. 26 illustrates VP transformation processing.

The VP (Virtual-Physical) transformation processing is executed by the VP transformation processing program 907. The VP transformation is transformation processing from the address of the logical storage area to the address of the physical storage area. The VP transformation processing is called from the page transformation processing or the like when an I/O request is received from the host 204. The page transformation processing transforms the address in the virtual volume designated by the I/O request into the address of the VPG space. The VP transformation processing transforms the address (VPG#, VDEV#, Vchunk#) of the VPG space that is the designated virtual address into the address (DPG#, PDEV#, Parcel#) of the DPG space that is the storage destination of the physical data.

First, the VP transformation processing program 907 calculates a Cycle Vchunk# from the Vchunk# (step S2601). The Cycle Vchunk# can be calculated by Cycle Vchunk#=Vchunk# mod c.

Subsequently, the VP transformation processing program 907 calculates a Local Vchunk# from the VPG#, the Cycle Vchunk#, and the number of period Vchunks C (step S2602).

The Local Vchunk# can be calculated by Local Vchunk#=VPG#×C+Cycle Vchunk#.

Subsequently, the VP transformation processing program 907 calculates the cycle# from the Vchunk# (step S2603). The cycle# can be calculated by cycle#=Floor (Vchunk#/c).

Subsequently, the VP transformation processing program 907 executes physical index acquisition processing (step S2604).

The physical index acquisition is processing of acquiring the DPG#, the PDEV#, and the Local Parcel# with the VPG#, the VDEV#, and the Local Vchunk# as inputs.

For example, the VP transformation processing program 907 acquires the DPG# from the VPG# using the PG mapping (V2P) table 808.

Subsequently, the VP transformation processing program 907 refers to the map pointer table 805, specifies the cycle map version 1203 with the DPG# and the cycle# as keys, and determines a plane of the cycle mapping table 806 to be referred to.

Subsequently, the VP transformation processing program 907 acquires the PDEV# and the Local Parcel# from the VDEV# and the Local Vchunk# using the cycle mapping table 806.

Subsequently, the VP transformation processing program 907 calculates the Parcel# from the Local Parcel#, the Cycle#, and the number of period Parcels m, and ends the processing (step S2605). The Parcel# can be calculated by Parcel#=Cycle#*m+Local Parcel#.

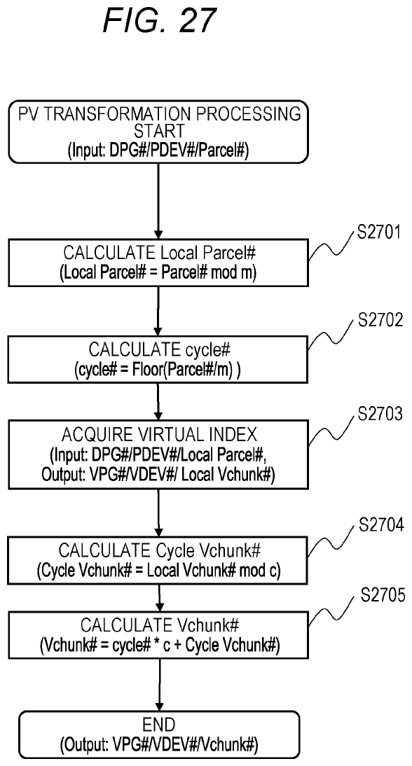

FIG. 27 illustrates PV transformation processing.

The PV (Physical-Virtual) transformation processing is executed by the PV transformation processing program 908. The PV transformation is transformation processing from the physical storage area to the logical storage area. For example, the PV transformation is processing used for specifying the data corresponding to the physical storage area failed in rebuilding processing. The PV transformation transforms the address (DPG#, PDEV#, Parcel#) of the DPG space that is the storage destination of the designated physical data into the address (VPG#, VDEV#, Vchunk#) of the VPG space that is the virtual address. The PV transformation corresponds to the inverse transformation of the VP transformation. That is, when the PV transformation is executed based on the result after the VP transformation is executed, the same address is returned. The inverse is also true.

First, the PV transformation processing program 908 calculates the Local Parcel# from the Parcel# (step S2701). The Local Parcel# can be calculated by Local Parcel#=Parcel# mod (m).

Subsequently, the PV transformation processing program 908 calculates the cycle# from the Parcel# (step S2702). The cycle# can be calculated by cycle#=Floor (Parcel#/m).

Subsequently, the PV transformation processing program 908 refers to the map pointer table 805, specifies the cycle map version 1203 with the DPG# and cycle# as keys, and determines the plane of the cycle mapping table 806 to be referred to.

Subsequently, the PV transformation processing program 908 executes virtual index acquisition (step S2703).

The virtual index acquisition is processing of acquiring the VPG#, the VDEV#, and the Local Vchunk# with the DPG#, the PDEV#, and the Local Parcel# as inputs.

For example, the PV transformation processing program 908 acquires the VPG# from the DPG# using the PG mapping (P2V) table 809, and acquires the VDEV# and the Local Vchunk# from the PDEV# and the Local Parcel# using the cycle mapping inverse transformation table 807. In this transformation, when the VDEV# and the Local Vchunk# are not allocated, this indicates that the Parcel is the spare area and the data is not allocated.

Subsequently, the PV transformation processing program 908 calculates the Cycle Vchunk# from the Local Vchunk#, the Cycle#, and the number of period Vchunks C (step S2704).

The Cycle Vchunk# can be calculated by Cycle Vchunk#=Local Vchunk# mod c.

Subsequently, the PV transformation processing program 908 calculates the Vchunk# from the Cycle Vchunk#, the Cycle#, and the number of period Vchunks C, and ends the processing (step S2705). The Vchunk# can be calculated by Vchunk#=Cycle#*C+Cycle Vchunk#.

According to the PV transformation processing described above, in the rebuilding processing, the storage controller 202 can transform the address of the DPG space of the failed physical device 107 into the address of the VPG space, and specify the data necessary for rebuilding.

Any drive decrease in the distributed RAID can be executed by the data arrangement and the data moving method described in the first embodiment.

### Second Embodiment

A second embodiment in which the method for designating the decrease drive is different will be described below. In the first embodiment, the method in which the user designates the decrease target drive is described. In the second embodiment, an example in which the user designates only the number of drives to be decreased and the storage system selects the decrease target is described. In the following description, a difference from the first embodiment will be mainly described based on the first embodiment.

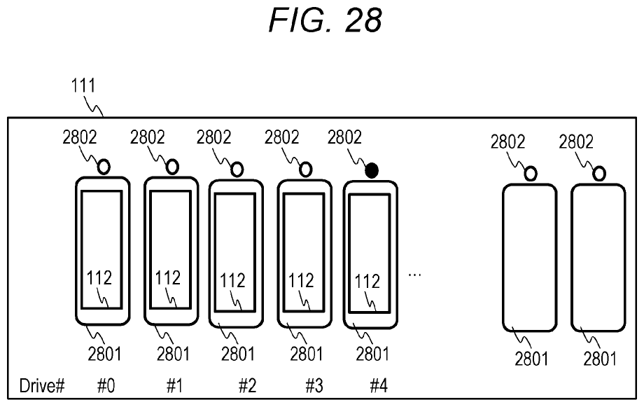

FIG. 28 illustrates a configuration of a drive enclosure of the second embodiment. The drive enclosure 111 includes a drive slot 2801 into which the physical device 112 is inserted and a display device 2802 for each drive slot. The display device 2802 is turned on or off by operation from the storage controller 202.

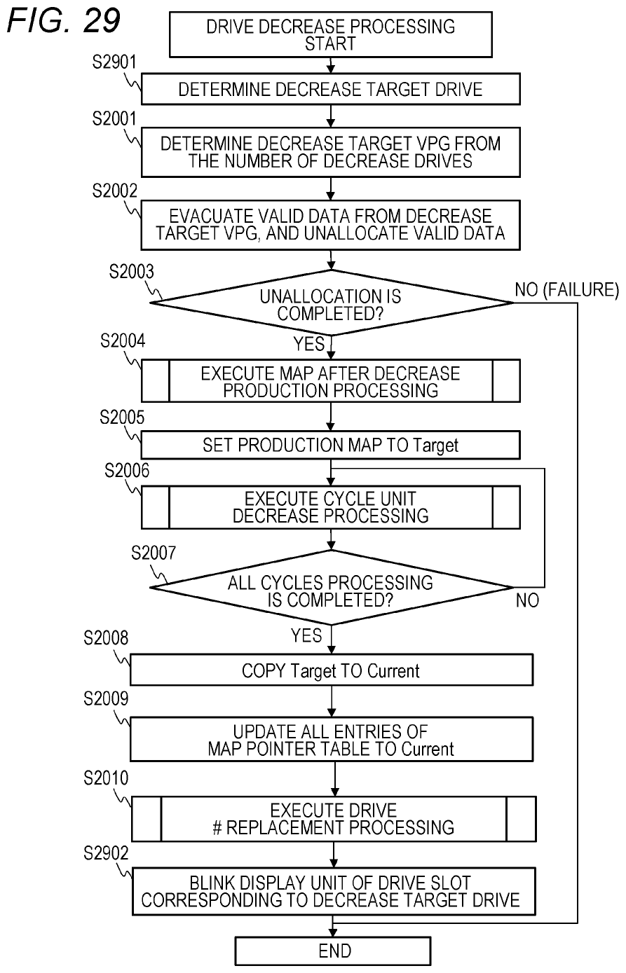

FIG. 29 illustrates drive decrease processing of the second embodiment. The drive decrease processing program 901 executes the decrease processing when the drive is decreased. The administrator designates at least one drive to be decreased in the system, and inputs a decrease instruction to the management server 203. The storage controller 202 executes the drive decrease processing of opportunity of receiving the decrease instruction from the management server 203.

Differences of the drive decrease processing in the second embodiment from the first embodiment will be described.

The drive decrease processing program 901 determines the decrease target drive based on the received number of decrease drives (step S2901). For example, the decrease target drive is selected as the tail drive. Thus, in the drive # replacement processing, the copy source PDEV and the copy destination PDEV become the same (Yes in step S2402), and the pieces of processing from step S2403 to step S2409 do not need to be executed, so that the time required for the decrease can be shortened.

Subsequently, the drive decrease processing program 901 determines the VPG# that becomes the operation target from the number of drives designated as the decrease target (step S2001). This processing is the same as that of the first embodiment. Thereafter, the same processing as in first embodiment is executed until step S2010.

Finally, the drive decrease processing program 901 causes the display unit 2802 corresponding to the drive slot 2801 into which the decrease target drive is inserted to blink to present the physical position of the decrease target drive to the user (step S2902). Consequently, the user can know which physical device is selected as the decrease target drive and that the decrease processing is completed, and the user can specify the target that is removed from the drive slot.

In the above description, the example in which the physical position of the decrease target drive is presented to the user immediately before the completion of the decrease processing program has been described. However, for example, the position may be presented to the user immediately after the decrease target drive is determined (step S2901). In that case, blinking by the presentation of the position and blinking by the completion of the decrease processing may be executed separately, and a blinking interval between them may be changed for the purpose of distinguishment.

In addition, after the position of the decrease target drive is presented to the user, reception of a continuation instruction of the decrease processing may be awaited from the user, and the decrease processing may be resumed after the continuation instruction is received.

In the present embodiment, the blinking of the display unit 2802 has been described as means for displaying the position of the decrease target drive, but the means is not limited thereto. The display may be displayed by changing intensity or color of the light of the display unit.

In addition, the display unit may display information such as a number of which the position of the drive slot can be uniquely identified on a screen provided in the drive enclosure 111.

In addition, images of the drive enclosure 111 and the display unit 2802 may be virtually displayed on a screen to display equivalent information.

The above embodiments are described in detail for the purpose of easy understanding of the present invention, but do not necessarily include all the described configurations. Furthermore, another configuration can be added to, deleted from, and replaced with other configurations for a part of the configuration of each embodiment.

In addition, some or all of the configurations, functions, processing units, processing means, and the like may be implemented by hardware in which design is performed by an integrated circuit. In addition, the present invention can also be implemented by a program code of software that implements the functions of the embodiments. In this case, a storage medium in which the program code is recorded is provided to a computer, and a processor included in the computer reads the program code stored in the storage medium. In this case, the program code itself read from the storage medium implements the functions of the embodiments, and the program code itself and the storage medium storing the program code constitute the present invention. For example, a flexible disk, a CD-ROM, a DVD-ROM, a hard disk, a solid state drive (SSD), an optical disk, a magneto-optical disk, a CD-R, a magnetic tape, a non-volatile memory card, and a ROM is used as the storage medium for supplying such the program code.

In addition, the program code implementing the functions described in the present embodiment can be mounted by a wide range of programs or script languages such as assembler, C/C++, perl, Shell, PHP, Java (registered trademark), and Python.

In the above-described embodiments, the control lines and the information lines indicate what is considered to be necessary for the description, and do not necessarily indicate all the control lines and the information lines on the product. All the configurations may be connected to each other.

What is claimed is:

1. A storage system comprising:
a processor; and
a plurality of physical devices,
wherein
the processor configures a virtual chunk with k (k is an integer of at least 2) virtual parcels having element data that is user data or redundant data for repairing the user data, and stores the virtual chunk in a virtual device, and
executes mapping of the virtual parcel included in an identical virtual chunk to k physical devices different from each other among N (k<N) physical devices,
when M (1≤M≤N−k) physical devices are decreased from N physical devices,
the processor selects M virtual devices, and moves the element data stored in the selected virtual device to another virtual device, and
allocates the virtual parcel allocated to a specific physical device to a plurality of unallocated areas located in the physical devices different from each other, the plurality of unallocated area being mapped to the virtual parcel in which data is not stored by moving the element data, and brings all the specific physical devices into an unallocated state.

2. The storage system according to claim 1, wherein the physical device that becomes a decrease target is the physical device increased last.

3. The storage system according to claim 1, wherein a number is assigned to each of the physical devices, and
the processor reassigns the number assigned to the physical device that becomes the decrease target to a last number after the virtual parcel allocated to the physical device that becomes the decrease target is moved to the specific physical device.

4. The storage system according to claim 1, wherein the virtual chunk includes B (B is a positive integer) virtual stripe rows including K stripes, and
the virtual parcel includes B stripes belonging to the virtual stripe rows different from each other.

5. The storage system according to claim 4, wherein a virtual parity group is configured by the K virtual devices,
in the virtual parity group, a Vchunk period is configured by c (c is a positive integer) virtual chunks,
a V chunk period group is configured by E (E is a positive integer) virtual parity groups constituting the Vchunk period, and
the virtual parcel is periodically allocated to the physical device for each of the Vchunk period group.

6. The storage system according to claim 1, wherein the processor accepts a specification input of a number of the physical devices that becomes the decrease target, and specifies the physical devices that becomes the decrease target based on the specification input.

7. The storage system according to claim 6, wherein when the physical device that becomes the decrease target is specified, the processor makes a notification of a position of the specified physical device.

8. A storage management method in a storage system including a processor and a plurality of physical devices,
the storage management method comprising:
configuring a virtual chunk with k (k is an integer of at least 2) virtual parcels having element data that is user data or redundant data for repairing the user data, and storing the virtual chunk in a virtual device; and
executing mapping of the virtual parcel included in an identical virtual chunk to k physical devices different from each other among N (k<N) physical devices,
when M (1≤M≤N−k) physical devices are decreased from N physical devices,
selecting M virtual devices, and moves the element data stored in the selected virtual device to another virtual device; and
allocating the virtual parcel allocated to a specific physical device to a plurality of unallocated areas located in the physical devices different from each other, the plurality of unallocated area being mapped to the virtual parcel in which data is not stored by moving the element data, and bringing all the specific physical devices into an unallocated state.
